(19) United States
(12) Patent Application Publication
(10) Pub. No.: US 2025/0055632 A1
(43) Pub. Date: Feb. 13, 2025

(54) TECHNIQUES FOR IDENTIFYING CHANNEL STATE INFORMATION REFERENCE SIGNAL RESOURCES FOR SPATIAL DOMAIN OR POWER DOMAIN ADAPTATION

(71) Applicant: QUALCOMM Incorporated, San Diego, CA (US)

(72) Inventors: Hung Dinh LY, San Diego, CA (US); Lei XIAO, San Jose, CA (US)

(21) Appl. No.: 18/653,701

(22) Filed: May 2, 2024

Related U.S. Application Data
(60) Provisional application No. 63/519,125, filed on Aug. 11, 2023.

(51) Int. Cl. H04L 5/00; H04W 24/08

(52) U.S. Cl. CPC H04L 5/0051; H04W 24/08

(57) ABSTRACT

Various aspects of the present disclosure generally relate to wireless communication. In some aspects, a user equipment (UE) may receive a channel state information (CSI) report configuration indicating a channel state information reference signal (CSI-RS) resource for channel measurement and a set of configurations, wherein each configuration of the set of configurations corresponds to a transmission setting for a CSI-RS. The UE may identify a number of CSI-RS resources and a number of CSI-RS ports for the CSI-RS resource, wherein the number of CSI-RS resources and the number of CSI-RS ports correspond to a subset of configurations of the set of sub-configurations and are based at least in part on a CSI-RS resource type of the CSI-RS. The UE may transmit one or more CSI reports based on the subset of the set of sub-configurations. Numerous other aspects are described.

### CROSS-REFERENCE TO RELATED APPLICATION

This Patent Application claims priority to Provisional Patent Application No. 63/519,125, filed on Aug. 11, 2023, entitled “TECHNIQUES FOR IDENTIFYING CHANNEL STATE INFORMATION REFERENCE SIGNAL RESOURCES FOR SPATIAL DOMAIN OR POWER DOMAIN ADAPTATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to identifying channel state information reference signal resources for spatial domain or power domain adaptation.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

In some aspects, a method of wireless communication performed by a user equipment (UE) includes receiving a channel state information (CSI) report configuration indicating a channel state information reference signal (CSI-RS) resource for channel measurement and a set of configurations, wherein each configuration of the set of configurations corresponds to a transmission setting for a CSI-RS; identifying a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS; and transmitting one or more CSI reports based on the subset of the set of configurations.

In some aspects, an apparatus for wireless communication at a UE includes one or more memories; and one or more processors, coupled to the one or more memories, configured to cause the UE to: receive a CSI report configuration indicating a CSI-RS resource for channel measurement and a set of configurations, wherein each configuration of the set of configurations corresponds to a transmission setting for a CSI-RS; identify a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS; and transmit one or more CSI reports based on the subset of the set of configurations.

In some aspects, a non-transitory computer-readable medium storing a set of instructions for wireless communication includes one or more instructions that, when executed by one or more processors of a UE, cause the UE to: receive a CSI report configuration indicating a CSI-RS resource for channel measurement and a set of configurations, wherein each configuration of the set of configurations corresponds to a transmission setting for a CSI-RS; identify a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS; and transmit one or more CSI reports based on the subset of the set of configurations.

In some aspects, an apparatus for wireless communication includes means for receiving a CSI report configuration indicating a CSI-RS resource for channel measurement and a set of configurations, wherein each configuration of the set of configurations corresponds to a transmission setting for a CSI-RS; means for identifying a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS; and means for transmitting one or more CSI reports based on the subset of the set of configurations.

In some aspects, a method of wireless communication performed by a network node includes transmitting a CSI report configuration indicating a CSI-RS resource for channel measurement and a set of configurations, wherein each configuration of the set of configurations indicates a transmission setting for a CSI-RS, wherein the transmission setting relates to at least one of a CSI-RS port configuration or a power offset of the CSI-RS; identifying a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS; and receiving one or more CSI reports based on the subset of configurations of the set of configurations.

In some aspects, an apparatus for wireless communication at a network node includes one or more memories; and one or more processors, coupled to the one or more memories, configured to cause the network node to: transmit a CSI report configuration indicating a CSI-RS resource for channel measurement and a set of configurations, wherein each configuration of the set of configurations indicates a transmission setting for a CSI-RS, wherein the transmission setting relates to at least one of a CSI-RS port configuration or a power offset of the CSI-RS; identify a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS; and receive one or more CSI reports based on the subset of configurations of the set of configurations.

In some aspects, a non-transitory computer-readable medium storing a set of instructions for wireless communication includes one or more instructions that, when executed by one or more processors of a network node, cause the network node to: transmit a CSI report configuration indicating a CSI-RS resource for channel measurement and a set of configurations, wherein each configuration of the set of configurations indicates a transmission setting for a CSI-RS, wherein the transmission setting relates to at least one of a CSI-RS port configuration or a power offset of the CSI-RS; identify a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS; and receive one or more CSI reports based on the subset of configurations of the set of configurations.

In some aspects, an apparatus for wireless communication includes means for transmitting a CSI report configuration indicating a CSI-RS resource for channel measurement and a set of configurations, wherein each configuration of the set of configurations indicates a transmission setting for a CSI-RS, wherein the transmission setting relates to at least one of a CSI-RS port configuration or a power offset of the CSI-RS; means for identifying a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS; and means for receiving one or more CSI reports based on the subset of configurations of the set of configurations.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of spatial adaptation, in accordance with the present disclosure.

FIGS. 5A-5B are diagrams illustrating examples of channel state information reference signal (CSI-RS) beam management procedures, in accordance with the present disclosure.

FIG. 6 is a diagram illustrating an example of CSI-RS ports, in accordance with the present disclosure.

FIG. 7 is a diagram illustrating an example of adaptation in the spatial domain and an example of adaptation in the power domain, in accordance with the present disclosure.

FIG. 8 is a diagram of an example associated with CSI-RS resource counting for reduced CSI-RS resources, in accordance with the present disclosure.

FIGS. 9-11 illustrate examples of counting CSI-RS ports and CSI-RS resources, in accordance with the present disclosure.

FIG. 12 is a diagram illustrating an example process performed, for example, at a UE or an apparatus of a UE, in accordance with the present disclosure.

FIG. 13 is a diagram of an example apparatus for wireless communication, in accordance with the present disclosure.

FIG. 14 is a diagram illustrating an example process performed, for example, at a network node or an apparatus of a network node, in accordance with the present disclosure.

FIG. 15 is a diagram of an example apparatus for wireless communication, in accordance with the present disclosure.

### DETAILED DESCRIPTION

A user equipment (UE) may measure channel state information (CSI) reference signals (CSI-RSs) and provide CSI feedback to a network entity for beam management and communication scheduling. The CSI-RSs may be part of a CSI-RS resource that is associated with a two-dimensional antenna array. A network entity (e.g., gNB) may transmit a CSI-RS signal associated with a full antenna array, and the UE may generate multiple CSIs for different antenna subarrays using the same received CSI-RS signal, referred to as spatial domain adaptation. Each subarray is associated with a subset of CSI-RS ports and the corresponding subset of time/frequency/code resources of the CSI-RS signal. The different subarrays are used by the UE for the purpose of CSI calculation. The UE may also generate CSI in accordance with a power offset value, referred to as power domain adaptation.

A UE may process CSI (e.g., generate CSI using measurements of a CSI-RS) in accordance with CSI processing metrics. For the purpose of this discussion, two CSI processing metrics are relevant: a central processing unit (CPU) occupancy, which provides a measure of processing load at the UE, and a number of simultaneously active CSI-RS resources and ports, which provides a measure of memory use. The UE reports, as part of its capability information, the number of simultaneous CPUs (via a parameter simultaneousCSl-ReportsPerCC in a component carrier, and a parameter simultaneousCSl-ReportsAllCC across all component carriers), denoted as N_{CPU}, the UE can handle. There is a running count, L, of occupied CPUs, representing the processing units that are in use by ongoing CSI reports. At any given time, the N_{CPU}-L unoccupied CPUs can be used to prepare additional CSI reports. Once there are no more unoccupied CPUs available, the UE will not process more CSI. The UE may still send CSI reporting even when no unoccupied CPUs are available, but for the CSI reports that are over the limit, the UE is allowed to send outdated reports. Any time a CSI calculation starts, the count L is incremented by O_{CPU}, where O_{CPU} is the load designation of the new CSI process. Any time a CSI calculation ends, the count L is decremented by O_{CPU}, where O_{CPU} is the load designation of the completed CSI process.

For an aperiodic CSI report, the CPU becomes occupied at the end of the last symbol of the physical downlink control channel (PDCCH) carrying the CSI trigger and the CPU is released at the end of the last symbol of the physical uplink shared channel (PUSCH) or physical uplink control channel (PUCCH) carrying the report. For the first report in a sequence of semi-persistent CSI reports on PUSCH, the CPU becomes occupied at the end of the last symbol of the PDCCH activating the CSI process and the CPU is released at the end of the last symbol of the PUSCH carrying the first report. For periodic and semi-persistent CSI reports, except for the first report in a sequence of semi-persistent CSI reports on PUSCH, the CPU becomes occupied at the latest CSI measurement resource (CSI-RS, CSI for IM (CSI-IM), or synchronization signal block (SSB)) that is usable for the report and the CPU is released at the end of the last symbol of the PUCCH or PUSCH carrying the report. The latest such CSI-RS resource is formally defined as the latest that is not later than the so-called CSI reference resource. The timing of the CSI reference resource is separately defined. If multiple CSI-RS resources are used for a given report and they do not occur at the same time, then the earliest of the multiple CSI-RS resources counts.

The UE may also report maximum numbers of simultaneously active CSI-RS resources and ports, such as a maximum number of simultaneously active non-zero-power (NZP) CSI-RS resources per component carrier (via a parameter maxNumberSimultaneousNZP-CSI-RS-PerCC), a maximum total number of ports in all simultaneously active NZP CSI-RS resources per component carrier (via a parameter NumberPortsSimultaneousNZP-CSI-RS-PerCC), a maximum number of simultaneously active NZP CSI-RS resources across all component carriers (via a parameter, maxNumberSimultaneousNZP-CSI-RS-ActBWP-AllCC), and a maximum total number of ports in all simultaneously active NZP CSI-RS resources across all component carriers (via a parameter totalNumberPortsSimultaneousNZP-CSI-RS-ActBWP-AllCC).

A CSI-RS resource may be considered active for the purposes of determining the number of simultaneously active CSI-RS resources according to the following rules. For an aperiodic CSI-RS resource, the CSI-RS resource and the CSI-RS ports within the resource become active at the end of the last symbol of the PDCCH carrying the CSI trigger and the CSI-RS resource becomes inactive at the end of the last symbol of the PUSCH carrying the report. For a semi-persistent CSI-RS resource, the CSI-RS resource and the ports within the resource become active at the time of the activation of the CSI-RS resource, and the CSI-RS resource becomes inactive at the time of the deactivation of the CSI-RS resource. For a periodic CSI-RS resource, the CSI-RS resource and the ports within the resource become active at the time of the configuration of the CSI-RS resource, and the CSI-RS resource becomes inactive at the time of the release of the CSI-RS resource configuration.

In some deployments, if a CSI-RS resource is referred to X times by one or more CSI reporting settings, the CSI-RS resource and the CSI-RS ports within the CSI-RS resource are identified (e.g., counted) X times. This may be based on an assumption that the CSI-RS resource must be stored in memory of the UE for each of the CSI reporting settings that refer to the CSI-RS resource. However, in spatial domain and power domain adaptation, multiple sub-configurations can apply to a given CSI-RS resource, and different combinations of the multiple sub-configurations can be active for CSI reporting at a given time. These different sub-configurations can also indicate different numbers of CSI-RS ports, leading to ambiguity in how CSI-RS resources and CSI-RS ports should be counted. This ambiguity may lead to suboptimal utilization of UE resources (such as memory and processor resources).

Aspects of the present disclosure relate generally to CSI reporting for spatial domain and/or power domain adaptation. Some aspects more specifically relate to identification (e.g., counting) of CSI-RS resources and/or ports in connection with spatial domain and/or power domain adaptation. In some aspects, the UE may receive a CSI report configuration indicating a CSI-RS resource for channel measurement and a set of configurations. Each configuration of the set of configurations may indicate a transmission setting for a CSI-RS, and the transmission setting may relate to at least one of a CSI-RS port configuration or a power offset of the CSI-RS. The UE may identify a number of active CSI-RS resources and a number of active CSI-RS ports for the CSI-RS resource associated with reporting for a CSI-RS. The number of active CSI-RS resources and the number of active CSI-RS ports may correspond to a subset of configurations of the set of configurations, and may be based at least in part on a CSI-RS resource type of the CSI-RS. For example, the subset may refer to the CSI-RS resource and may be active for CSI reporting.

Particular aspects of the present disclosure may be used to realize one or more of the following possible advantages. In some aspects, by identifying a number of CSI-RS resources and CSI-RS ports corresponding to a subset of configurations of the set of configurations, ambiguity in how CSI-RS resources and ports should be counted is reduced. Furthermore, the UE may more effectively utilize processor and memory resources, and may provide CSI reporting at a level of complexity suited to the UE's processor and memory resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

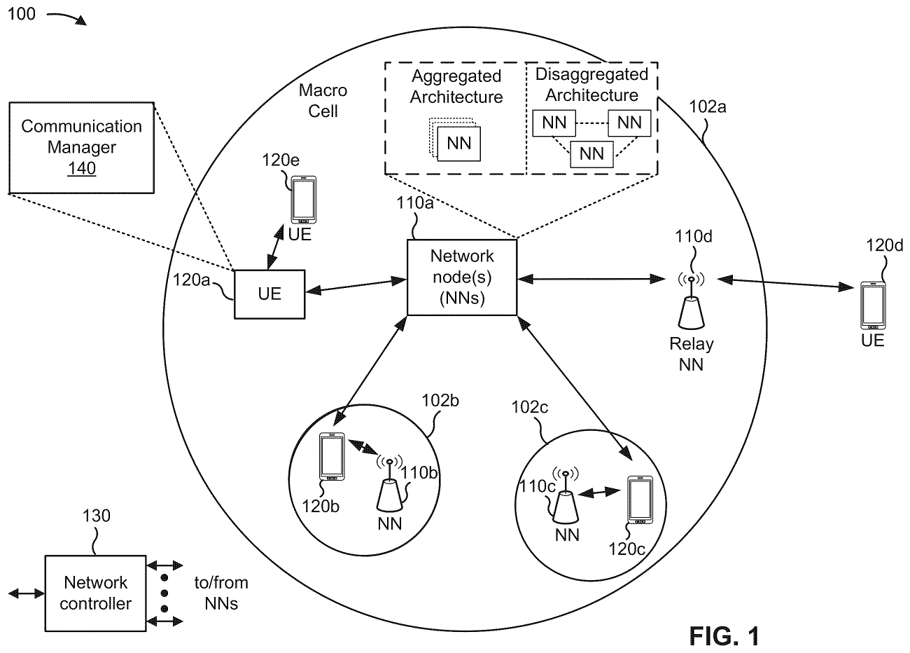

FIG. 1 is a diagram illustrating an example of a wireless network 100, in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a CSI report configuration indicating a CSI-RS resource for channel measurement and a set of sub-configurations, wherein each sub-configuration of the set of sub-configurations corresponds to a transmission setting for a CSI-RS; identify a number of CSI-RS resources and a number of CSI-RS ports for the CSI-RS resource, wherein the number of CSI-RS resources and the number of CSI-RS ports correspond to a subset of sub-configurations of the set of sub-configurations; and transmit one or more CSI reports based on the subset of the set of sub-configurations. Additionally, or alternatively, the communication manager 140 may perform one or more other operations described herein.

As indicated above, FIG. 1 is provided as an example. Other examples may differ from what is described with regard to FIG. 1.

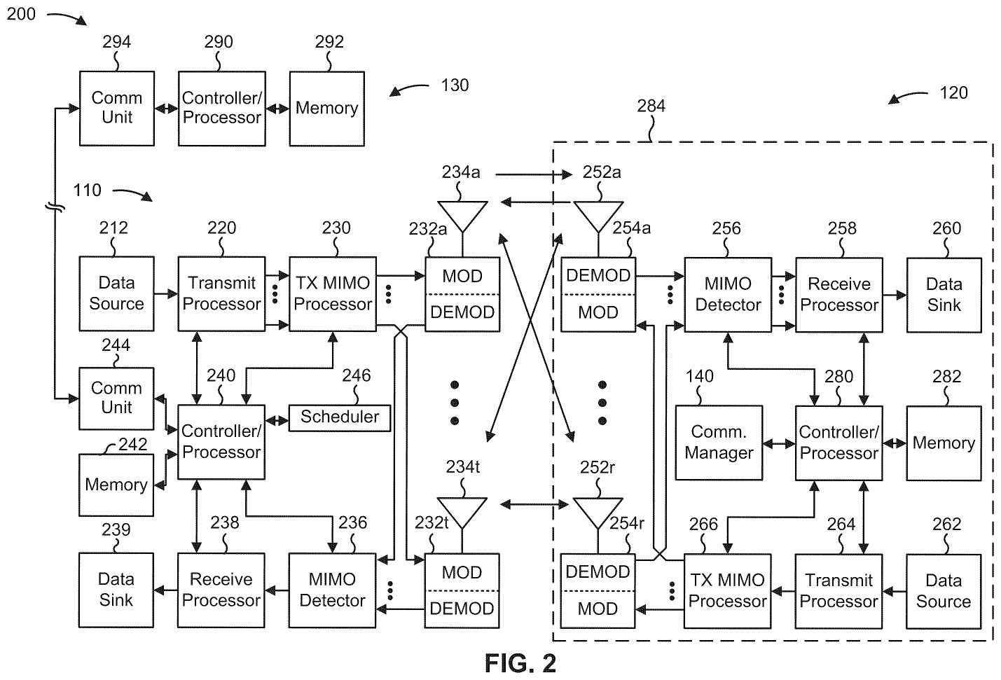

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

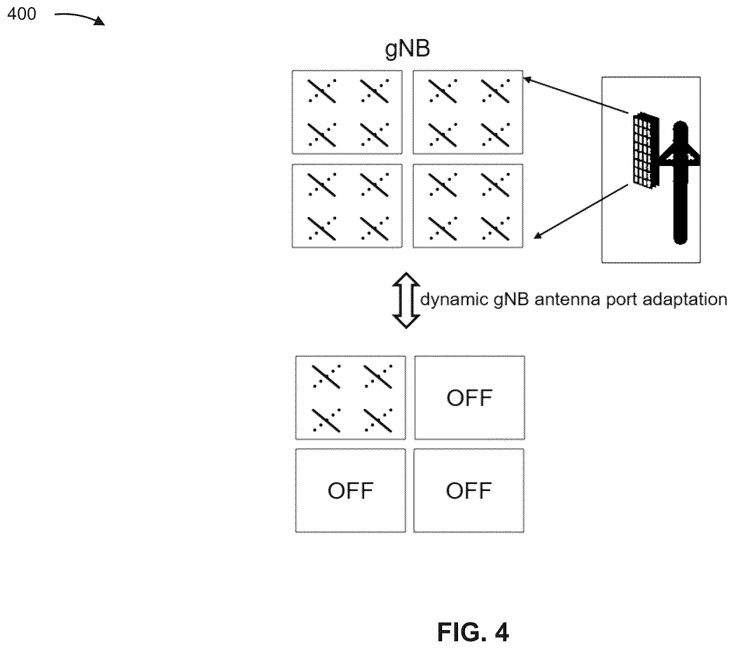

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-11).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-11).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

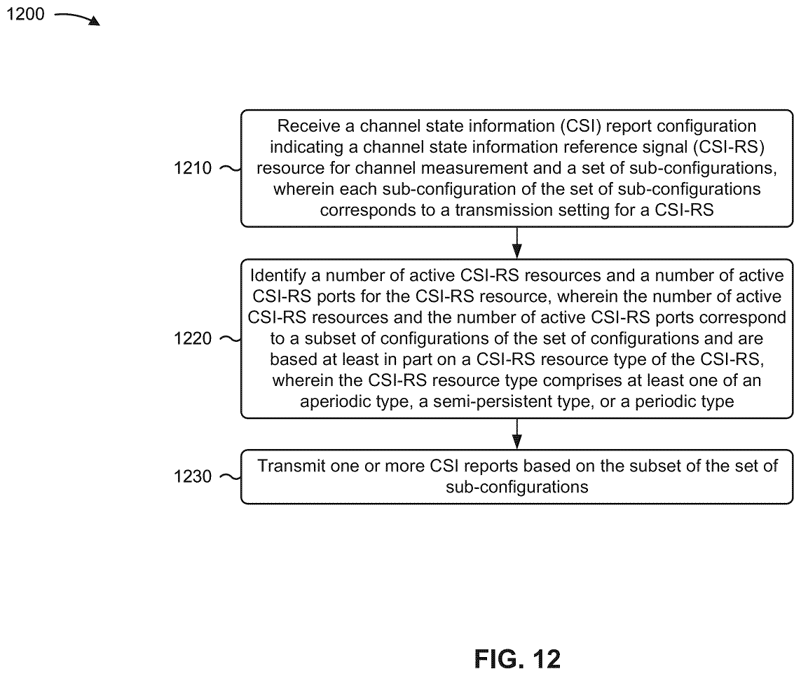

The controller/processor 240 of the network node 110, the controller/processor 280 of the UE 120, or any other component(s) of FIG. 2 may perform one or more techniques associated with CQI computation, as described in more detail elsewhere herein. For example, the controller/processor 240 of the network node 110, the controller/processor 280 of the UE 120, or any other component(s) (or combinations of components) of FIG. 2 may perform or direct operations of, for example, process 1200 of FIG. 12, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for receiving a CSI report configuration indicating a CSI-RS resource for channel measurement and a set of sub-configurations, wherein each sub-configuration of the set of sub-configurations corresponds to a transmission setting for a CSI-RS; means for identifying a number of CSI-RS resources and a number of CSI-RS ports for the CSI-RS resource, wherein the number of CSI-RS resources and the number of CSI-RS ports correspond to a subset of sub-configurations of the set of sub-configurations; and/or means for transmitting one or more CSI reports based on the subset of the set of sub-configurations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving a channel state information (CSI) report configuration indicating a channel state information reference signal (CSI-RS) resource for channel measurement and a set of configurations, wherein each configuration of the set of configurations indicates a transmission setting for a CSI-RS, wherein the transmission setting relates to at least one of a CSI-RS port configuration or a power offset of the CSI-RS; means for identifying a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS; and means for transmitting one or more CSI reports based on the subset of configurations of the set of configurations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

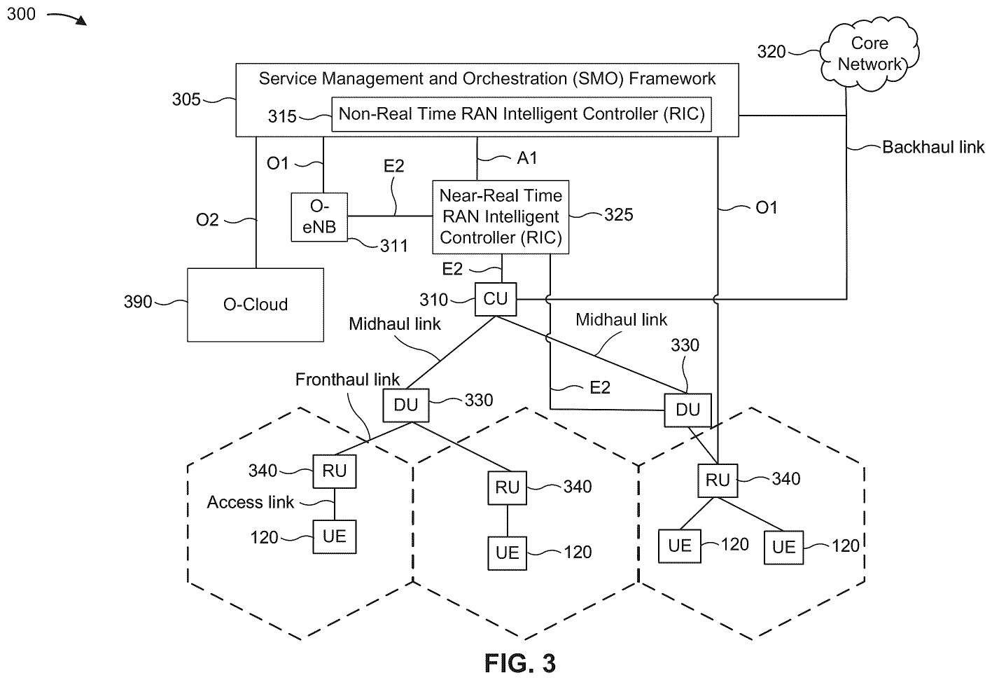

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an 02 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of spatial adaptation, in accordance with the present disclosure.

Massive MIMO provides high spectral efficiency and extended coverage by communicating using a large number of antennas. For downlink transmission, a network node supporting massive MIMO may be equipped with a large number of transceiver chains (e.g., 64 transceiver chains in FR1 are typically deployed in commercial 5G networks, especially at carrier frequencies of 3.5 GHz and/or higher). Each transceiver chain may be connected to one or more power amplifiers. The power amplifiers may consume a significant portion of the network node's energy (e.g., 70%-80% of base station power). To control or reduce network power consumption, a cell can turn on or off one or more power amplifiers (such as depending on the time and frequency resource utilization in the cell). Equivalently, a cell can turn on or off one or more transceiver chains.

Spatial adaptation at a network node may include deactivating one or more antenna panels (spatial elements, ports) such that fewer antenna panels are active. Example 400 shows four antenna panels of a network node (e.g., gNB). The network node may deactivate three of the four antenna panels. The three deactivated panels are shown as OFF. Indications related to spatial adaptation may help UEs to adapt a CSI-RS configuration to dynamic or semi-persistent activation or deactivation of CSI-RS, or to reconfigure the CSI-RS configuration with respect to an adapted number of spatial elements or ports. A network entity may dynamically select CSI report configurations via a selected triggering state (e.g., CSI-AperiodicTriggerStateList, CSI-SemiPersistentOnPUSCH-TriggerStateList), such as by a medium access control control element (MAC CE) or downlink control information (DCI).

Power control offsets may be used to adapt a transmit power for CSI-RSs. In a first step, CSI feedback may be provided for adaptation of power offset values. In a second step, a physical downlink shared channel (PDSCH) may be transmitted with a suitable power offset configuration.

As indicated above, FIG. 4 is provided as an example. Other examples may differ from what is described with regard to FIG. 4.

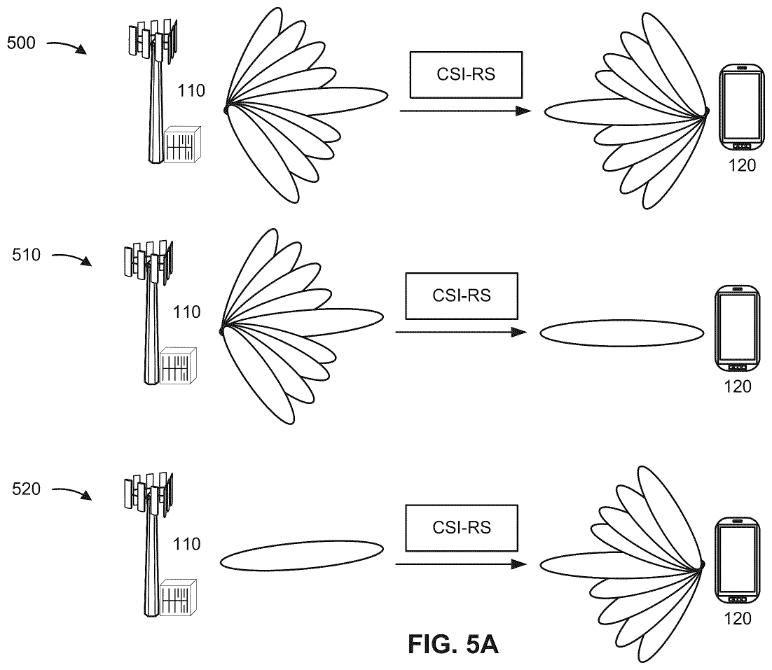

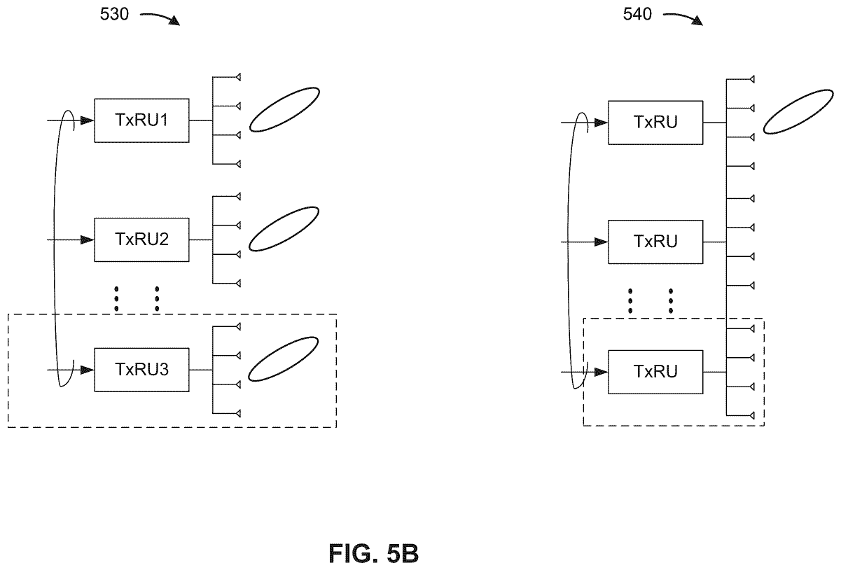

FIGS. 5A-5B are diagrams illustrating examples of CSI-RS beam management procedures, in accordance with the present disclosure. As shown in FIG. 5A, a UE 120 is in communication with a network node 110 in a wireless network (e.g., wireless network 100). However, the devices shown in FIG. 5A are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 5A, example 500 may include a network node 110 (e.g., one or more network node devices such as an RU, a DU, and/or a CU, among other examples) and a UE 120 communicating to perform beam management using CSI-RSs. Example 500 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 5A and example 500, CSI-RSs may be configured to be transmitted from the network node 110 to the UE 120. The CSI-RSs may be configured to be periodic (e.g., using RRC signaling), semi-persistent (e.g., using medium access control element (MAC-CE) signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same reference signal (RS) resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 500 has been described in connection with CSI-RSs, the first beam management process may also use synchronization signal blocks (SSBs) for beam management in a similar manner as described above.

As shown in FIG. 5A, example 510 may include a network node 110 and a UE 120 communicating to perform beam management using CSI-RSs. Example 510 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 5A and example 510, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 5A, example 520 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 5 and example 520, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

In some cases, as shown in FIG. 5B and by reference number 530, the on/off capabilities may be associated with a logical antenna port associated with a plurality of transmit receive units (TxRUs) (such as TxRU1, TxRU2, and TxRU3), and the logical antenna port may be turned on or off. This may be referred to as Type 1 spatial domain (SD) adaptation. In Type 1 SD adaptation, a TxRU can be activated or deactivated. In some other cases, referred to as Type 2 SD adaptation and shown by reference number 540, the configuration of physical antenna elements for CSI-RS or PDSCH is adapted. This type of adaptation may be useful for FR2, where the number of TxRUs at the network node is limited (such as 1 or 2 TxRUs). In Type 2 SD adaptation, the number of logical antenna ports may remain unchanged while the number of physical antenna elements can be adapted, hence impacting beamforming gain.

In some cases, such as from a CSI perspective, Type 1 SD adaptation may be the adaptation of antenna ports or transceiver chains at network node. In contrast, Type 2 SD adaptation may be the adaptation of transmission power offset values between CSI-RS and SSB.

In some cases, one non-zero power (NZP) CSI-RS resource configuration for channel measurement within one resource setting corresponding to more than one spatial adaptation pattern may be supported. A spatial adaptation pattern may indicate a set of antenna elements or logical antenna ports to be activated or deactivated. In some cases, a resource set with multiple resources may be configured within a resource setting, where each resource is associated with only one spatial adaptation pattern. In some other cases, for a resource configured in a resource set within a resource setting, the resource can be associated with more than one spatial adaptation pattern. One or more resources can be configured in the resource set for channel measurement. In some cases, one CSI report configuration may include multiple CSIs report sub-configurations, where each sub-configuration corresponds to a single spatial adaptation pattern. For a sub-configuration of a CSI report configuration, the UE 120 may be configured with a port subset indication (e.g., a bitmap). The UE 120 may derive a reduced NZP CSI-RS resource from the corresponding NZP CSI-RS resource configured in the CSI-RS resource set of channel management. Configurations of CSI-RS resources and CSI-RS port configurations, including reduced configurations corresponding to spatial adaptation patterns, are described elsewhere herein.

In some cases, a CSI feedback (CSF) framework may include multiple steps. A first step (e.g., step 1) may be associated with CSF for adaptation of spatial elements. A second step (e.g., step 2) may be associated with identifying or transmitting a physical downlink shared channel (PDSCH) with a suitable configuration of spatial elements. In some cases, for a CSI report configuration with L sub-configuration(s), a framework that enables a UE to report N CSI(s) in one reporting instance, where the N CSI(s) are associated with N sub-configuration(s) from L (where 1≤N≤L) and each CSI corresponds to one sub-configuration, may be supported. N=1 may refer to single-CSI signaling while N>1 may refer to multi-CSI signaling.

In some cases, for a CSI report configuration, for each sub-configuration for Type 1 SD adaptation, at least the following may be included: one or more parameters in a codebook configuration (CodebookConfig), and a port subset indication or resource grouping. The one or more parameters in the codebook configuration may include, for example, n1-n2, and ng for multi-panel. In some cases, the one or more parameters may also include a rank restriction, a codebook subset restriction, and/or supported codebook types for a PMI (e.g., Type-I or Type-II). The port subset indication or resource grouping may indicate, for example, a report quantity, a report frequency configuration (reportFreqConfiguration), and/or whether it is explicitly provided or can also be derived (e.g., from the CodebookConfig and/or from the CSI-RS resource configuration). For a CSI report configuration, at least the following can be included for each sub-configuration for Type 2 SD adaptation: an NZP CSI-RS resource set for channel measurement, where different resources can have different power offsets between a CSI-RS and SSB. In some cases, a report quantity can also be included.

In one example, a CSI report configuration for Type 1 SD adaptation in accordance with a port subset indication may have three sub-configurations. The CSI report configuration may have a 32-port NZP CSI-RS resource set (for channel measurement). A first sub-configuration (sub-configuration 1) may have a first spatial adaptation pattern (spatial adaptation pattern 1) and may have a first codebook configuration (codebook configuration 1) with (N1, N2)=(8, 2). A second sub-configuration (sub-configuration 2) may have a second spatial adaptation pattern (spatial adaptation pattern 2) and may have a second codebook configuration (codebook configuration 2) with (N1, N2)=(8, 1). Additionally, the second sub-configuration may have 16-port NZP CSI-RS resource(s), where each resource is a subset of a 32-port CSI-RS resource in a CSI-RS resource set and corresponds to a uniform linear array (ULA) with (N1, N2) in codebook 2. A third sub-configuration (sub-configuration 3) may have a third spatial adaptation pattern (spatial adaptation pattern 3) and may have a third codebook configuration (codebook configuration 3) with (N1, N2)=(4, 1). The third sub-configuration may have 8-port NZP CSI-RS resource(s), where each resource is a subset of a 32-port CSI-RS resource in a CSI-RS resource set and corresponds to a ULA with (N1, N2) in codebook 3. In some cases, the resource subset may be determined based at least in part on a port subset indication. The network node 110 may transmit a CSI-RS using a 32-port NZP CSI-RS resource. The UE 120 may measure the 32-port NZP CSI-RS resource, and may derive CSI from the measurement. The CSI may relate to at least one of the 32-port NZP CSI-RS resource or one or more of the sub-configurations, depending on which of the sub-configurations is active for the CSI reporting. In Type 2 SD adaptation, the CSI report configuration may indicate a set of P-port CSI-RS resources for channel measurement, and may indicate one or more sub-configurations, where each sub-configuration indicates a set of CSI resource index identifiers corresponding to one or more CSI-RS resources of the set of P-port CSI-RS resources. In Type 2 SD adaptation, the network node 110 may transmit CSI-RSs using each CSI-RS resource indicated by any active sub-configuration of the one or more sub-configurations.

In another example, a CSI report configuration for Type 1 SD adaptation, in accordance with resource grouping may have three sub-configurations. The CSI report configuration may have a 32-port NZP CSI-RS resource set (for channel measurement). A first sub-configuration (sub-configuration 1) may have a first spatial adaptation pattern (spatial adaptation pattern 1) and may have a first codebook configuration (codebook configuration 1) with (N1, N2)=(8, 2). A second sub-configuration (sub-configuration 2) may have a second spatial adaptation pattern (spatial adaptation pattern 2) and may have a second codebook configuration (codebook configuration 2) with (N1, N2)=(8, 1). Additionally, the second sub-configuration may have a 16-port NZP CSI-RS resource set for channel measurement. A third sub-configuration (sub-configuration 3) may have a third spatial adaptation pattern (spatial adaptation pattern 3) and may have a third codebook configuration (codebook configuration 3) with (N1, N2)=(4, 1). Additionally. The third sub-configuration may have an 8-port NZP CSI-RS resource set for channel measurement. In some cases, there may be no relationship between the resources in the different sub-configurations.

In some cases, a dynamic adaptation of power offset values between PDSCH and CSI-RS may be beneficial for network energy savings. A network node may be able to compensate for some measurements (such as Layer 1 (L1) RSRP and CQI) in accordance with a transmission power difference between an actual power offset and a configured power offset used by the UE for the CSI report. This may be beneficial when the transmission power difference is not large. However, when the transmission power difference is large, the compensation at the network node may not be accurate for parameters such as rank indicator (RI) and/or PMI. In some cases, the dynamic adaptation of the power offset values between PDSCH and CSI-RS can be identified in accordance with an example two-step process. In a first step (e.g., step 1), a CSF for adaptation of power offset values may be identified. In a second step (e.g., step 2), a PDSCH with a suitable power offset configuration may be identified. In some cases, a configuration of more than one power offset value for the PDSCH relative to the CSI-RS may be supported.

In some cases, a framework for power domain (PD) adaptation may be similar to the framework for the spatial domain adaptation described above (e.g., for Type 2 SD). Differences between the SD adaptation and the PD adaptation may be in the sub-configurations, as described below.

For a CSI report configuration with L sub-configuration(s), a framework that enables a UE to report N CSI(s) in one reporting instance, where the N CSI(s) are associated with N sub-configuration(s) from L (where 1≤N≤L) and each CSI corresponds to one sub-configuration, may be supported. N=1 may refer to single-CSI while N>1 may refer to multi-CSI.

As described in 3GPP Technical Specification (TS) 38.321, Release 17, section 5.18.6, for reporting on a physical uplink control channel (PUCCH), the UE may receive an activation command via a MAC-CE. The network may activate and deactivate the configured semi-persistent CSI reporting on the PUCCH of a serving cell by sending the SP CSI reporting on a PUCCH activation/deactivation MAC-CE. The configured semi-persistent CSI reporting on the PUCCH may be initially deactivated upon configuration and after a handover. In this case, if the MAC entity receives an SP CSI reporting on PUCCH activation/deactivation MAC-CE on a serving cell, the MAC entity may indicate, to lower layers, the information regarding the SP CSI reporting on PUCCH activation/deactivation MAC-CE. In some cases, the SP CSI on PUCCH activation/deactivation MAC-CE may be identified by a MAC subheader with a logical channel ID (LCID). The MAC subheader may have a serving cell ID field, a bandwidth part (BWP) ID field, an Si field, and a reserved bit (R) field, as described in as described in 3GPP TS 38.321 section 6.1.3.16, Release 17.

In some cases, a UE may receive triggering information for reporting CSI. In some cases, the UE may receive DCI that indicates for the UE to aperiodically report CSI via a physical uplink shared channel (PUSCH). A list of trigger states may be configured in a CSI aperiodic trigger state list (CSI-AperiodicTriggerStateList), and each trigger state included in the list of trigger states may include a list of associated reporting settings. In some other cases, the UE may receive DCI that indicates for the UE to semi-persistently report CSI via the PUSCH. A list of trigger states may be configured in a CSI semi-persistent state list (CSI-SemiPersistentOnPUSCH-TriggerStateList), and each trigger state included in the list of trigger states may include a list of associated reporting settings. In some other cases, the UE may receive a MAC-CE that indicates for the UE to semi-persistently report CSI via a PUCCH. In some cases, for a CSI report configuration with L sub-configuration(s), the UE may be configured to report N CSI(s) in a single reporting instance, where the N CSI(s) are associated with N sub-configuration(s) from L (where 1≤N≤L) and each CSI corresponds to a single sub-configuration.

As indicated above, FIGS. 5A-5B are provided as examples. Other examples may differ from what is described with regard to FIGS. 5A-5B.

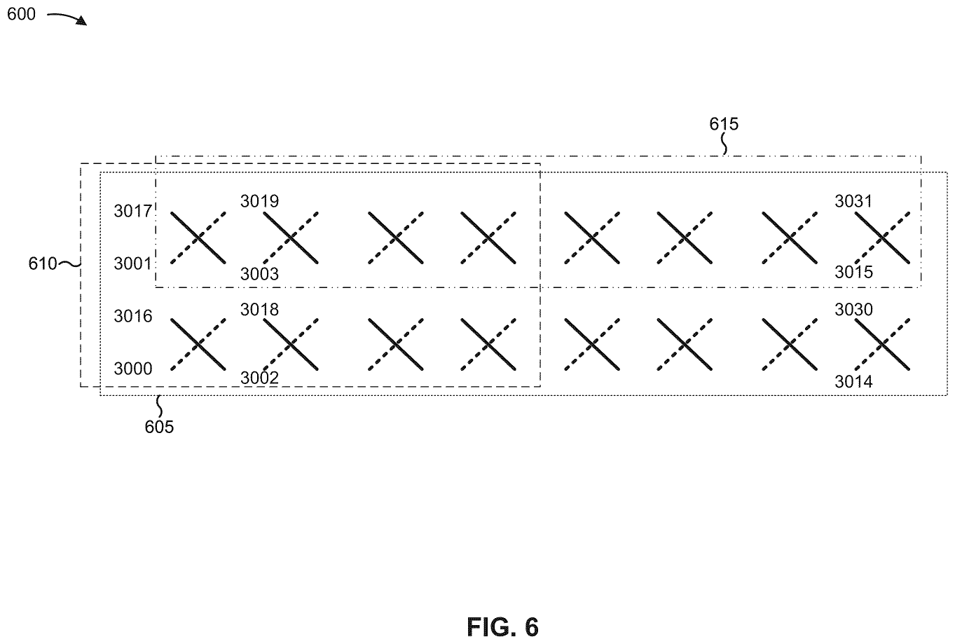

FIG. 6 is a diagram illustrating an example 600 of CSI-RS ports, in accordance with the present disclosure. A CSI-RS port may be referred to as a CSI-RS antenna port. CSI-RS ports are indicated by a CSI-RS resource configuration, and are associated with port numbers. A CSI-RS port's number may be based at least in part on a CSI-RS sequence index, a code division multiplexing (CDM) group size, and a total number of CSI-RS ports. CSI-RS ports are numbered starting at 3000. In particular, CSI-RS ports are numbered as {3000, 3001} for 2 CSI-RS ports, 4 CSI-RS ports {3000, 3001, 3002, 3003}, 8 CSI-RS ports {3000, 3001, . . . , 3007}, 12 CSI-RS ports {3000, 3001, . . . , 3011}, 16 CSI-RS ports {3000, 3001, . . . , 3015}, 24 CSI-RS ports {3000, 3001, . . . , 3023}, and 32 CSI-RS ports {3000, 3001, . . . , 3031}.

A UE may calculate a CQI of CSF using CSI-RS port numbering. For example, the CSI-RS port numbering may allow the UE to identify or assume an antenna relationship between the CSI-RS and a PDSCH. In particular, for CQI calculation, the UE may assume that PDSCH signals on antenna ports in the set [1000, . . . , 1000+v−1] for v layers would result in signals equivalent to corresponding symbols transmitted on antenna ports [300, . . . , 3000+P−1], as given by

$$[ \begin{matrix}{y}^{( 3000 )} ( i ) \\ … \\ {y}^{( 3000 + P - 1 )} ( i )\end{matrix} ] = W ( i ) [ \begin{matrix}{x}^{( 0 )} ( i ) \\ … \\ {x}^{( v - 1 )} ( i )\end{matrix} ] ,$$

where x(i)=[x⁽⁰⁾(i) . . . x^{(v-1)}(i)]^{T} is a vector of PDSCH symbols from a defined layer mapping, P is a number of CSI-RS ports, and W(i) is a precoding matrix. If only one CSI-RS port is configured, W(i) may be 1 (one). If the higher layer parameter reportQuantity in CSI-ReportConfig for which the CQI is reported is set to either ‘cri-RI-PMI-CQI’ or ‘cri-RI-LI-PMI-CQI’, W(i) may be the precoding matrix corresponding to the reported PMI applicable to x(i). If the higher layer parameter reportQuantity in CSI-ReportConfig for which the CQI is reported is set to ‘cri-RI-CQI’, W(i) may be the precoding matrix corresponding to a procedure described in Clause 5.2.1.4.2 of 3GPP TS 38.214, Release 17. If the higher layer parameter reportQuantity in CSI-ReportConfig for which the CQI is reported is set to ‘cri-RI-il-CQI’, W(i) is the precoding matrix corresponding to the reported ii according to the procedure described in Clause 5.2.1.4.2 of 3GPP TS 38.214, Release 17.

Reference number 605 illustrates a first CSI-RS port configuration corresponding to a first CSI-RS resource. As shown, the first CSI-RS port configuration includes 32 CSI-RS ports (P=32), numbered 3000 through 3031. The first CSI-RS resource may be considered a 32-port NZP CSI-RS resource, and may be configured (via a first configuration) in an NZP CSI-RS resource set for channel management with CSI-RS port configuration (N1, N2)=(8, 2), corresponding to 2 rows and 8 columns of CSI-RS ports. Each of the CSI-RS ports of the first CSI-RS port configuration may be referred to as active CSI-RS ports, since each of these CSI-RS ports may be measured to compute CSI using a CSI-RS transmitted in accordance with the first CSI-RS port configuration. “Active CSI-RS port” may be used interchangeably with “CSI-RS port for CSI measurement” herein. A CSI-RS resource may be configured for channel measurement, meaning that the CSI-RS resource is used to derive CSI for a channel. Other types of CSI-RS resource may include zero-power CSI-RS resources and CSI-RS resources for interference measurement.

Reference number 610 illustrates a second CSI-RS port configuration that is a subset (e.g., a proper subset) of the first CSI-RS port configuration. For example, the second CSI-RS port configuration may be configured, via a second configuration, using a port subset indication. The port subset indication may include a P-bit bitmap that indicates which CSI-RS ports, of the first CSI-RS port configuration, are active (that is, used for measurement of CSI) in the second CSI-RS port configuration. In this example, the 32-bit bitmap may include values (1 1 1 1 1 1 1 1 0 0 0 0 0 0 0 0 1 1 1 1 1 1 1 1 0 0 0 0 0 0 0 0) which means that CSI-RS ports {3000, 3001, 3002, . . . , 3007, 3016, 3017, . . . , 3023} are used for CQI computation. The remaining CSI-RS ports may not be used for CSI measurement or CQI computation, and thus may be referred to as inactive in this context. The second CSI-RS port configuration may be associated with a second CSI-RS resource that is associated with the first CSI-RS resource and is a subset of the first CSI-RS resource. “Measurement of a CSI-RS” or “measurement of a channel” may include taking one or more samples at a time and/or frequency and/or spatial resource identified by a CSI-RS resource. These samples can then be used to determine CSI.

Reference number 615 illustrates a third CSI-RS port configuration that is a subset (e.g., a proper subset) of the first CSI-RS port configuration. For example, the third CSI-RS port configuration may be configured, via a third configuration, using a port subset indication. The port subset indication may include a P-bit bitmap that indicates which CSI-RS ports, of the first CSI-RS port configuration, are active in the second CSI-RS port configuration. In this example, the 32-bit bitmap may include values (0 1 0 1 0 1 0 1 0 1 0 1 0 1 0 1 0 1 0 1 0 1 0 1 0 1 0 1 0 1 0 1) which means that odd CSI-RS ports {3001, 3003, 3005, . . . , 3015, 3017, 3019, . . . , 3031} are used for CQI computation. The third CSI-RS port configuration may be associated with a third CSI-RS resource that is associated with the first CSI-RS resource and is a subset of the first CSI-RS resource.

A network node 110 may transmit a CSI-RS in accordance with the first CSI-RS resource (referred to as transmitting the first CSI-RS resource). The UE 120 may determine CSI (e.g., compute CQI) by measuring the CSI-RS and applying parameters of the second configuration and/or the third configuration. For example (such as in Type 1 SD adaptation and power domain adaptation), the UE 120 may determine CSI for any active sub-configuration of a CSI-RS resource (or a CSI-RS resource set) using a CSI-RS transmitted in accordance with the CSI-RS resource. In some aspects (such as in Type 2 SD adaptation) the network node 110 may transmit CSI-RSs in accordance with each activated sub-configuration.

As indicated above, FIG. 6 is provided as an example. Other examples may differ from what is described with regard to FIG. 6.

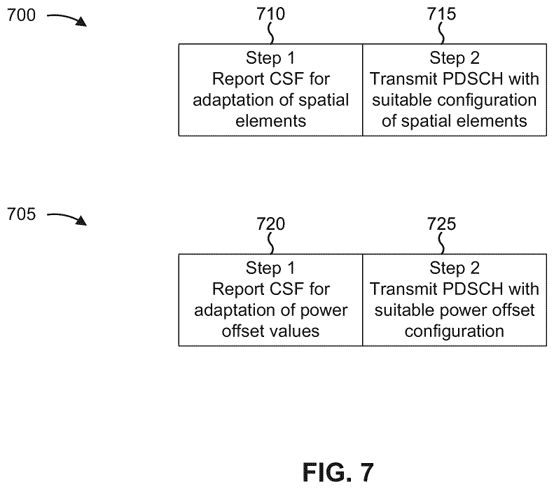

FIG. 7 is a diagram illustrating an example 700 of adaptation in the spatial domain and an example 705 of adaptation in the power domain, in accordance with the present disclosure. Example 700 may include reporting of CSF (shown by reference number 710) and configuration and/or transmission of a PDSCH with a configuration of spatial elements (shown by reference number 715). Example 705 may include reporting of CSF (as shown by reference number 720) and configuration and/or transmission of a PDSCH with a power offset configuration (shown by reference number 725).

As shown by reference number 710, the UE may report CSF. For example, the UE may report the CSF for adaptation (e.g., activation, deactivation, reconfiguration) of spatial elements such as antennas. A network node (e.g., a network node 110) may configure a CSI report configuration with multiple sub-configurations. Each sub-configuration may correspond to a CSI-RS antenna port configuration. The UE may measure and report CSI according to all of the sub-configurations or according to a subset of the sub-configurations. For example, the network node may provide an indication of which sub-configurations are to be reported. As shown by reference number 715, the network node may transmit a PDSCH with a suitable configuration of spatial elements. For example, the network node may switch among different configurations of active spatial elements based on CSI reports (e.g., CSF) from the UE.

As shown by reference number 720, the UE may report CSF. For example, the UE may report the CSF for adaptation (e.g., activation, deactivation, reconfiguration) of power offset values. A network node (e.g., a network node 110) may configure a CSI report configuration with multiple sub-configurations. Each sub-configuration may correspond to a power offset value. The UE may measure and report CSI according to all of the sub-configurations or according to a subset of the sub-configurations. For example, the network node may provide an indication of which sub-configurations are to be reported. As shown by reference number 725, the network node may transmit a PDSCH with a suitable power offset configuration. For example, the network node may switch among different configurations of power offsets based on CSI reports (e.g., CSF) from the UE. Transmitting a communication or signal using a certain power offset relative to another communication or signal (or relative to a baseline power value) may be referred to as adaptation in the power domain. In some aspects, for a CSI report configuration with L sub-configuration(s), a UE may report N CSI(s) in one reporting instance, where the N CSI(s) are associated with N sub-configuration(s) from L (where 1≤N≤L) and each CSI corresponds to one sub-configuration.

It should be noted that spatial domain adaptation can be performed jointly with power domain adaptation (e.g., for the same communication). It should also be noted that a sub-configuration can be applied for transmission of a CSI-RS from which the CSF described with regard to reference numbers 710 and 720 is derived. For example, the network node may transmit a CSI-RS using a number of ports or a power offset indicated by a sub-configuration. Alternatively, the network node may transmit a CSI-RS using a baseline CSI-RS resource configuration (e.g., a first CSI-RS resource, a first CSI-RS port configuration, a first power offset) and may transmit the PDSCH shown by reference number 715 or 725 using a sub-configuration based at least in part on the CSF received by the network node at reference number 710 or 720.

As indicated above, FIG. 7 is provided as an example. Other examples may differ from what is described with regard to FIG. 7.

A UE may process CSI (e.g., generate CSI using measurements of a CSI-RS) in accordance with CSI processing metrics. For the purpose of this discussion, two CSI processing metrics are relevant: a central processing unit (CPU) occupancy, which provides a measure of processing load at the UE, and a number of simultaneously active CSI-RS resources and ports, which provides a measure of memory use. The UE reports, as part of its capability information, the number of simultaneous CPUs (via a parameter simultaneousCSl-ReportsPerCC in a component carrier, and a parameter simultaneousCSl-ReportsAllCC across all component carriers), denoted as N_{CPU}, the UE can handle. There is a running count, L, of occupied CPUs, representing the processing units that are in use by ongoing CSI reports. At any given time, the N_{CPU}-L unoccupied CPUs can be used to prepare additional CSI reports. Once there are no more unoccupied CPUs available, the UE will not process more CSI. The UE may still to send CSI reporting even when no unoccupied CPUs are available, but for the CSI reports that are over the limit, the UE is allowed to send outdated reports. Any time a CSI calculation starts, the count L is incremented by O_{CPU}, where O_{CPU} is the load designation of the new CSI process. Any time a CSI calculation ends, the count L is decremented by O_{CPU}, where O_{CPU} is the load designation of the completed CSI process.

For an aperiodic CSI report, the CPU becomes occupied at the end of the last symbol of the PDCCH carrying the CSI trigger and the CPU is released at the end of the last symbol of the PUSCH or PUCCH carrying the report. For the first report in a sequence of semi-persistent CSI reports on PUSCH, the CPU becomes occupied at the end of the last symbol of the PDCCH activating the CSI process and the CPU is released at the end of the last symbol of the PUSCH carrying the first report. For periodic and semi-persistent CSI reports, except for the first report in a sequence of semi-persistent CSI reports on PUSCH, the CPU becomes occupied at the latest CSI measurement resource (CSI-RS, CSI-IM, or SSB) that is usable for the report and the CPU is released at the end of the last symbol of the PUCCH or PUSCH carrying the report. The latest such CSI-RS resource is formally defined as the latest that is not later than the so-called CSI reference resource. The timing of the CSI reference resource is separately defined. If multiple CSI-RS resources are used for a given report and they do not occur at the same time, then the earliest of the multiple CSI-RS resources counts.

The UE may also report maximum numbers of simultaneously active CSI-RS resources and ports, such as a maximum number of simultaneously active NZP CSI-RS resources per component carrier (via a parameter maxNumberSimultaneousNZP-CSI-RS-PerCC), a maximum total number of ports in all simultaneously active NZP CSI-RS resources per component carrier (via a parameter NumberPortsSimultaneousNZP-CSI-RS-PerCC), a maximum number of simultaneously active NZP CSI-RS resources across all component carriers (via a parameter, maxNumberSimultaneousNZP-CSI-RS-ActBWP-AllCC), and a maximum total number of ports in all simultaneously active NZP CSI-RS resources across all component carriers (via a parameter totalNumberPortsSimultaneousNZP-CSI-RS-ActBWP-AllCC).

A CSI-RS resource may be considered active for the purposes of determining the number of simultaneously active CSI-RS resources according to the following rules. For an aperiodic CSI-RS resource, the CSI-RS resource and the CSI-RS ports within the resource become active at the end of the last symbol of the PDCCH carrying the CSI trigger and the CSI-RS resource becomes inactive at the end of the last symbol of the PUSCH carrying the report. For a semi-persistent CSI-RS resource, the CSI-RS resource and the ports within the resource become active at the time of the activation of the CSI-RS resource, and the CSI-RS resource becomes inactive at the time of the deactivation of the CSI-RS resource. For a periodic CSI-RS resource, the CSI-RS resource and the ports within the resource become active at the time of the configuration of the CSI-RS resource, and the CSI-RS resource becomes inactive at the time of the release of the CSI-RS resource configuration.

In some deployments, if a CSI-RS resource is referred to X times by one or more CSI reporting settings, the CSI-RS resource and the CSI-RS ports within the CSI-RS resource are identified (e.g., counted) X times. This may be based on an assumption that the CSI-RS resource must be stored in memory of the UE for each of the CSI reporting settings that refer to the CSI-RS resource. However, in spatial domain and power domain adaptation, multiple sub-configurations can apply to a given CSI-RS resource, and different combinations of the multiple sub-configurations can be active for CSI reporting at a given time. These different sub-configurations can also indicate different numbers of CSI-RS ports, leading to ambiguity in how CSI-RS resources and CSI-RS ports should be identified (e.g., counted). This ambiguity may lead to suboptimal utilization of UE resources (such as memory and processor resources).

Aspects of the present disclosure relate generally to CSI reporting for spatial domain and/or power domain adaptation. Some aspects more specifically relate to identifying (e.g., counting) active CSI-RS resources and/or ports in connection with spatial domain and/or power domain adaptation. In some aspects, the UE may identify (e.g., count) a number of active CSI-RS resources and a number of active CSI-RS ports associated with reporting for a CSI-RS, where the CSI-RS is measured in accordance with at least a sub-configuration that comprises an adaptation of a CSI-RS resource (or a configuration of the CSI-RS resource) with regard to at least one of a power domain or a spatial domain.

Particular aspects of the present disclosure may be used to realize one or more of the following possible advantages. In some aspects, by identifying (e.g., counting) a number of CSI-RS resources and CSI-RS ports associated with reporting for a CSI-RS measured in accordance with at least the sub-configuration, ambiguity in how CSI-RS resources and ports should be identified (e.g., counted) is reduced. Furthermore, the UE may more effectively utilize processor and memory resources, and may provide CSI reporting at a level of complexity suited to the UE's processor and memory resources.

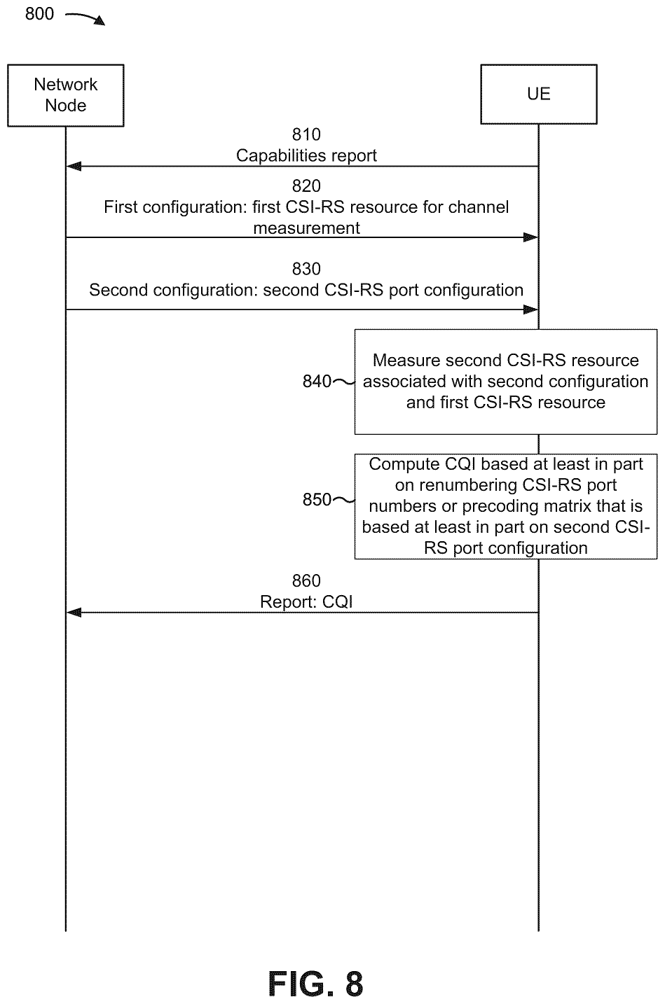

FIG. 8 is a diagram of an example 800 associated with CSI-RS resource identifying (e.g., counting) for reduced CSI-RS resources, in accordance with the present disclosure. As shown in FIG. 8, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 8.

As shown by reference number 810, the UE may transmit, and the network node may receive, a capabilities report. The capabilities report may indicate whether the UE supports a feature and/or one or more parameters related to the feature. For example, the capability information may indicate a capability and/or parameter for identifying (e.g., counting) active CSI-RS ports or active CSI-RS resources. One or more operations described herein may be based on capability information of the capabilities report. For example, the UE may receive a CSI report configuration in accordance with the capability information, or may compute a new CSI report only if the UE's capabilities are not exceeded. In some aspects, the capability information may be at a per UE granularity, a per band granularity, a per band combination granularity, or a per band and per band combination granularity.

In some aspects, the capability may be specific to identifying (e.g., counting) active CSI-RS resources and/or ports when one or more sub-configurations are configured or indicated. For example, the UE may report a UE capability on identifying (e.g., counting) active CSI-RS resources and/or ports. The UE may identify (e.g., count) the active CSI-RS resources and/or ports in accordance with the UE capability. If the UE does not report this UE capability, then the UE may apply techniques described below to identify (e.g., count) the CSI-RS resources and ports.

As shown by reference number 820, the network node may transmit, and the UE may receive, a CSI report configuration indicating a CSI-RS resource for channel measurement. The CSI report configuration may also indicate a set of sub-configurations, which may be referred to herein as a set of configurations. The CSI-RS resource for channel measurement can be contrasted against CSI-RS resources for other purposes such as interference measurement. The CSI-RS resource may include a CSI-RS port configuration that indicates a number of CSI-RS ports, as described above. For example, the CSI report configuration may include or indicate a CSI-RS resource configuration (of the CSI-RS resource) that indicates the first CSI-RS port configuration, which is described with regard to FIG. 6. In some aspects, the CSI report configuration indicating a CSI-RS resource for channel measurement and L sub-configurations of the CSI-RS resource, as described with regard to FIG. 6. In some aspects, the CSI report configuration may include or be associated with (e.g., linked to, directly or via the CSI-RS resource) one or more trigger states. A trigger state may indicate a condition that triggers determination and reporting of a CSI report, and may additionally indicate one or more sub-configurations for which the CSI report is to be determined and reported. In some aspects, the sub-configurations are referred to as configurations.

In some aspects, the CSI report configuration may configure a set of CSI-RS resources for channel measurement. For example, the CSI report configuration may configure multiple CSI-RS resources, each associated with one or more sub-configurations. As another example, the CSI report configuration may configure a first CSI-RS resource and a set of sub-configurations, where each sub-configuration can be used to derive a second CSI-RS resource from the first CSI-RS resource.

Each sub-configuration of the set of sub-configurations may correspond to a transmission setting for a CSI-RS. For example, the CSI-RS may be transmitted or measured according to a sub-configuration of the set of sub-configurations, such as by modifying the CSI-RS resource or a CSI report configuration of the CSI-RS resource in accordance with the sub-configuration. A transmission setting may generally indicate a CSI-RS port configuration or a power offset. For example, a transmission setting associated with a CSI-RS may indicate a CSI antenna port configuration for Type 1 spatial domain adaptation, a power offset between the CSI-RS and an SSB for Type 2 spatial domain adaptation, or a power offset between a PDSCH and a CSI-RS for power domain adaptation.

As shown by reference number 830, in some aspects, the network node may transmit, and the UE may receive, an indication of a subset of sub-configurations of the set of sub-configurations (sometimes referred to as a subset of configurations of a set of configurations). For example, the indication may include DCI carrying a CSI trigger (which may include an indication of the subset of sub-configurations), such as for an aperiodic CSI report or a semi-persistent CSI report on a PUSCH. As another example, the indication may include a MAC-CE including an indication of the subset of sub-configurations. In some aspects, the UE may provide CSI reporting without receiving an indication of a subset of sub-configurations. For example, the UE may provide CSI reporting for all sub-configurations of the set of sub-configurations. In other words, the subset of sub-configurations can include all sub-configurations of the set of sub-configurations.

In some aspects, the configuration information described in connection with reference numbers 820 and/or 830, and/or the capabilities report, may include information transmitted via multiple communications. Additionally, or alternatively, the network node may transmit the configuration information, or a communication including at least a portion of the configuration information, before and/or after the UE transmits the capabilities report. For example, the network node may transmit a first portion of the configuration information before the capabilities report, the UE may transmit at least a portion of the capabilities report, and the network node may transmit a second portion of the configuration information after receiving the capabilities report. In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples. The UE may configure itself based at least in part on the configuration information. In some aspects, the UE may be configured to perform one or more operations described herein based at least in part on the configuration information.

As shown by reference number 840, the UE may measure the CSI-RS resource. For example, the UE may perform a measurement of a CSI-RS on the CSI-RS resource, in accordance with parameters of the CSI report configuration.

As shown by reference number 850, the UE may determine one or more CSI reports. For example, the UE may determine one or more CSI parameters (e.g., CQI, layer indicator (LI), rank indicator (RI), or the like) using the measurement of the CSI-RS resource. As another example, the UE may determine the one or more CSI parameters in accordance with an indicated subset of sub-configurations that refer to and/or are activated for the CSI-RS resource. As another example, the UE may determine the one or more CSI parameters in accordance with all sub-configurations of the set of sub-configurations.

The UE may identify (e.g., count) a number of active CSI-RS resources and a number of active CSI-RS ports for the CSI-RS resource. The number of active CSI-RS resources may indicate how many instances of the CSI-RS resource are loaded into a memory of the UE. For example, the number of active CSI-RS resources may indicate a memory load at the UE. The CSI-RS resource may be associated with a number of active CSI-RS resources that is greater than one, in some instances. For example, in some aspects, a sub-configuration referring to the CSI-RS resource may be identified (e.g., counted) in the number of active CSI-RS resources. The number of active CSI-RS ports may indicate how many CSI-RS ports are active for determination of CSI reporting for the CSI-RS resource. In some aspects, the network node may not be permitted to configure a CSI report configuration that causes the number of active CSI-RS resources or ports to exceed a capability of the UE.

In some aspects, identifying (e.g., counting) the number of active CSI-RS resources and the number of active CSI-RS ports is based at least in part on a CSI-RS resource type of the CSI-RS, wherein the CSI-RS resource type comprises at least one of an aperiodic type, a semi-persistent type, or a periodic type. This is referred to herein as Approach 1. Approach 1 may be based at least in part on a subset of the sub-configurations, which may be indicated as described above in connection with reference number 830. For Approach 1, the subset of the sub-configurations may include M sub-configurations, where M is an integer. The subset of the sub-configurations may refer to the CSI-RS resource. For example, the subset of the sub-configurations may identify the CSI-RS resource, or may be received in a same configuration as the CSI-RS resource. The subset of the sub-configurations may be usable for CSI measurement and reporting. Note that the subset of sub-configurations may include all sub-configurations of the set of sub-configurations, in some aspects. Identifying the number of active CSI-RS resources and CSI-RS ports based at least in part on the CSI-RS resource type may be beneficial because different CSI-RS resource types may occupy CSI processing units in different fashions. For example, an aperiodic CSI-RS resource may only occupy CSI processing units between a CSI trigger and report transmission, whereas a semi-persistent or periodic CSI-RS resource may occupy CSI processing units for a longer period of time.

In Approach 1, for Type 1 spatial domain adaptation (that is, when the subset of sub-configurations are associated with adaptation of logical antenna ports), identifying (e.g., counting) the number of active CSI-RS resources and the number of active CSI-RS ports may include identifying (e.g., counting) M CSI-RS resources (e.g., the UE may identify (e.g., count) the CSI-RS M times when the CSI-RS is referred to by M sub-configurations that can be used for CSI measurement and reporting) and/or T CSI-RS ports, wherein T is an integer. T may be based at least in part on at least one of a sum of numbers of active CSI-RS ports of the subset of sub-configurations (where a number of CSI-RS ports of a sub-configuration s is denoted Pₛ), or a number of CSI-RS ports configured in the CSI-RS resource (denoted P). For example, T may be defined as T=max((Σₛ₌₁^{M}Pₛ), P), where P is the number of CSI-RS ports of the CSI-RS resource configured in a CSI-RS resource set for channel measurement and Pₛ is the number of CSI-RS ports in sub-configuration.

Additionally, or alternatively, in Approach 1 and for Type 2 spatial domain adaptation (in which the configuration of physical antenna elements for CSI-RS and/or PDSCH is adapted, such as via a power offset) or power domain adaptation (in which a power offset between a CSI-RS and a PDSCH is implemented), identifying (e.g., counting) the number of active CSI-RS resources and the number of active CSI-RS ports may include identifying (e.g., counting) a number of active CSI-RS ports configured in the CSI-RS resource M times.

As mentioned, in Approach 1, the identifying (e.g., counting) may be based at least in part on a CSI-RS resource type of the CSI-RS. For example, M may be based at least in part on the CSI-RS resource type. For an aperiodic CSI-RS (which may be used only for an aperiodic CSI report), M=N, where N is the number of sub-configurations indicated to the UE via DCI for CSI measurement and reporting. For a semi-persistent CSI-RS resource or a periodic CSI-RS resource, in some aspects, M=L, where L is the number of sub-configurations configured in the CSI report configuration of reference number 820.

Alternatively, for a semi-persistent CSI-RS resource or a periodic CSI-RS resource, M may be the number of sub-configurations in the union of sub-configurations indicated in trigger states associated with the CSI report configuration. For example, consider a CSI report configuration indicating a semi-persistent or periodic CSI-RS resource for channel measurement. The CSI report configuration may have 4 sub-configurations numbered 0, 1, 2, and 3. The configuration information shown by reference number 820 may indicate 3 trigger states (e.g., aperiodic trigger states). A first trigger state may be associated with sub-configurations 1, 2, and 3. A second trigger state may be associated with sub-configurations 1 and 2. A third trigger state may be associated with sub-configuration 2. In this example, the union of sub-configurations indicated in the trigger states may include sub-configurations 1, 2, and 3, so M is 3.

In some aspects, the UE may identify (e.g., count) the number of active CSI-RS resources and the number of active CSI-RS ports in a first stage and a second stage, referred to as Approach 2. The two stages are described separately for clarity, and may be implemented as a single stage or operation in practice. In some aspects, identifying (e.g., counting) the number of active CSI-RS resources and the number of active CSI-RS ports may include a first stage of identifying (e.g., counting) the CSI-RS resource (e.g., identifying (e.g., counting) the CSI-RS resource configured in the resource set for channel measurement), and a second stage of identifying (e.g., counting) the number of active CSI-RS resources and the number of active CSI-RS ports in association with the subset of sub-configurations. For example, in the second stage, the UE may identify (e.g., count) CSI-RS resources associated with sub-configurations. A CSI-RS resource associated with a sub-configuration may include a CSI-RS resource that is derived from the CSI-RS resource configured (such as at reference number 820) in a resource set for channel measurement and from parameters of the sub-configuration.

In some aspects, identifying (e.g., counting) the number of active CSI-RS resources and the number of active CSI-RS ports in association with the subset of sub-configurations is based at least in part on an active time of the CSI-RS resource and CSI-RS ports of the CSI-RS resource. For example, as mentioned, in the second stage, the UE may identify (e.g., count) CSI-RS resources associated with sub-configurations. For a CSI-RS resource associated with a sub-configuration (e.g., a CSI-RS resource derived from the CSI-RS resource configured in the resource set for channel measurement and the parameters in a sub-configuration), the active time may be based at least in part on a CSI-RS resource type of the CSI-RS resource associated with the sub-configuration. Additionally, or alternatively, the active time may be based at least in part on whether the CSI report is an aperiodic CSI report, a semi-persistent CSI report, or a periodic report. Additionally, or alternatively, the active time may be based at least in part on whether the CSI report is transmitted on a PUSCH or a PUCCH.

The active time may start at a start time and end at an end time. The start time is a time at which the CSI-RS resource or port becomes active. The end time is a time at which the CSI-RS or port becomes inactive. For example, for an aperiodic CSI report or a semi-persistent CSI report on a PUSCH, the CSI-RS resource and the CSI-RS ports of the CSI-RS resource (indicated by a port subset indication) may become active at an end of a last symbol of a PDCCH carrying DCI with a trigger for the CSI (which may contain a subset indication indicating the subset of the sub-configurations), and may become inactive at an end of a scheduled PUSCH containing the triggered CSI report. For a semi-persistent CSI report on a PUCCH, the CSI-RS resource and the CSI-RS ports of the CSI-RS resource (indicated by a port subset indication for Type 1 spatial domain adaptation) may become active at an end of when a MAC-CE containing a subset indication indicating the subset of sub-configurations is applied, and may become inactive at an end of a scheduled PUCCH containing the triggered CSI report. For a periodic CSI report, the CSI-RS resource and the CSI-RS ports within the CSI-RS resource (indicated by a port subset indication for Type 1 spatial domain adaptation) may become active when the corresponding periodic CSI-RS configuration in a CSI-RS resource set for channel measurement is configured by higher layer signaling (such as RRC signaling, at reference number 820) and may become inactive when the corresponding periodic CSI-RS configuration is released.

In some aspects, the subset of sub-configurations includes X sub-configurations, wherein X is an integer. The X sub-configurations may be indicated to the UE via DCI or a MAC-CE, as described elsewhere herein, for CSI measurement and reporting. The X sub-configurations may refer to the CSI-RS resource, as described elsewhere herein. In this example, in Approach 2, identifying (e.g., counting) the number of CSI-RS resources and the number of CSI-RS ports in association with the subset of sub-configurations may include identifying (e.g., counting) Y CSI-RS resources, where Y is equal to X minus 1. For example, the CSI-RS resource may be identified (e.g., counted) Y=X−1 times. In some aspects, identifying (e.g., counting) the number of CSI-RS ports may include identifying (e.g., counting) T CSI-RS ports, wherein T is an integer. T may be based at least in part on at least one of a sum of numbers of active CSI-RS ports of the subset of sub-configurations (where a number of CSI-RS ports of a sub-configuration s is denoted Pₛ), a number of CSI-RS ports configured in the CSI-RS resource (denoted P), or a number of sub-configurations indicated via DCI or a MAC-CE to the UE for CSI reporting (denoted N). For example, T may be defined as T=max((Σₛ₌₁^{N}Pₛ), P), where P is the number of CSI-RS ports of the CSI-RS resource configured in a CSI-RS resource set for channel measurement and P_{S} is the number of CSI-RS ports in sub-configuration. In some aspects, N may differ from X because X indicates a number of sub-configurations that refer to the CSI-RS resource and are indicated via DCI/MAC signaling for CSI measurement and reporting, whereas N indicates a number of sub-configurations indicated to the UE for CSI reporting. In some aspects, N and X may be equal.

In some aspects, the UE may determine the one or more CSI reports in accordance with a processing timeline. In some aspects, the processing timeline may be based at least in part on the number of active CSI-RS resources or the number of active CSI-RS ports. For example, a processing timeline defined by a parameter Z or Z′ may be increased relative to a baseline for a high complexity CSI report (or relative to a baseline for a fast CSI report or a low complexity CSI report). The baseline for the high complexity CSI report is shown in Table 1. Z may indicate a minimum time between an end of a PDCCH triggering an aperiodic CSI-RS report and a PUSCH carrying CSI derived from the CSI-RS, or between an end of a PDCCH scheduling a PUSCH carrying CSI for a periodic or semi-persistent CSI-RS and the PUSCH. Z′ may indicate a minimum time between the CSI-RS and the PUSCH or PUCCH carrying the CSI for the CSI-RS.

TABLE 1

| SCS | Z (symbols) | | Z (μs) | |
|---|---|---|---|---|
| (kHz) | Z | Z′ | Z | Z′ |
| 15 | 40 | 37 | 2854.2 | 2640.1 |
| 30 | 72 | 69 | 2568.8 | 2461.7 |
| 60 | 141 | 140 | 2515.2 | 2497.4 |
| 120 | 152 | 140 | 1355.7 | 1248.7 |

As shown by reference number 860, the UE may transmit the one or more CSI reports. For example, the UE may transmit the one or more CSI reports via a PUCCH or a PUSCH. The one or more CSI reports may include one or more CSI parameters relating to a subset of sub-configurations, such as a proper subset of the set of sub-configurations or all sub-configurations of the set of sub-configurations.

As indicated above, FIG. 8 is provided as an example. Other examples may differ from what is described with regard to FIG. 8.

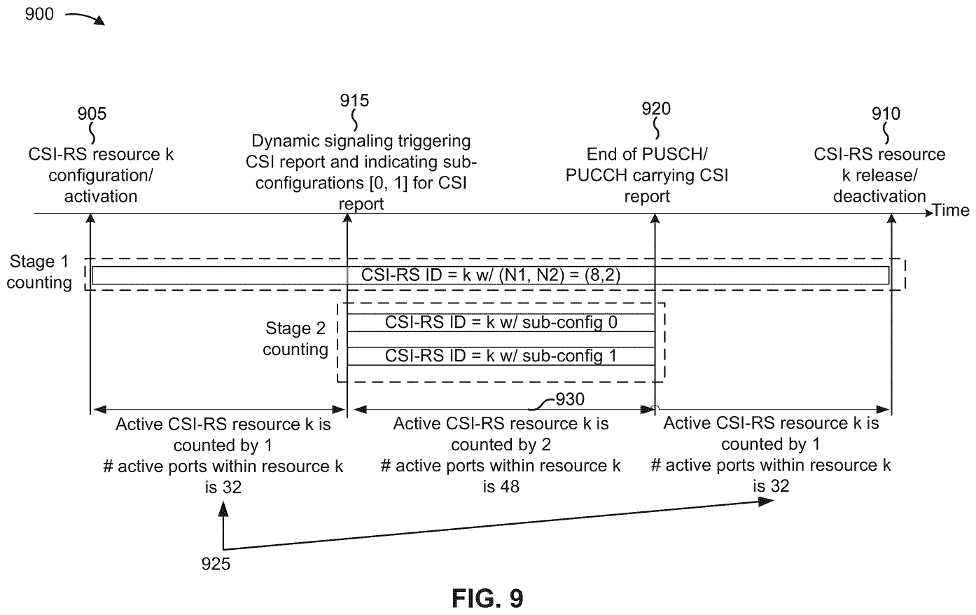

FIGS. 9-11 illustrate examples of identifying (e.g., counting) active CSI-RS ports and active CSI-RS resources, in accordance with the present disclosure. In FIGS. 9-11, a CSI report configuration (such as indicated by reference number 820) may have 32 CSI-RS ports. For example, a 32-port NZP CSI-RS resource denoted k may be configured in an NZP CSI-RS resource set for channel measurement with a CSI-RS port configuration (N1, N2) of (8, 2), as described elsewhere herein. The CSI report configuration may also (implicitly or explicitly) indicate a set of 4 sub-configurations:
Sub-configuration 0 (32 CSI-RS ports): (N1, N2)=(8, 2), and a port subset indication includes a 32-bit bitmap of all ones or the port subset indication may be skipped.
Sub-configuration 1 (16 CSI-RS ports): (N1, N2)=(4, 2), and a port subset indication including a 32-bit bitmap (1 1 1 1 1 1 1 10 0 0 0 0 0 0 0 1 1 1 1 1 1 11 0 0 0 0 0 0 0 0) which means CSI-RS ports {3000, 3001, 3002, . . . , 3007, 3016, 3017, . . . , 3023} are used for CQI computation.
Sub-configuration 2 (16 CSI-RS ports): (N1, N2)=(8, 1), and a port subset indication including a 32-bit bitmap (0 10 10 10 10 10 10 10 1 0 10 10 1 0 1 0 1 0 1 0 1 0 1) which means odd CSI-RS ports {3001, 3003, 3005, . . . , 3015, 3017, 3019, . . . , 3031} are used for CQI computation.
Sub-configuration 3 (8 CSI-RS ports): (N1, N2)=(4, 1), and a port subset indication including a 32-bit bitmap (0 10 10 10 10 0 0 0 0 0 0 0 0 10 10 1 0 1 0 0 0 0 0 00 0) which means odd CSI-RS ports {3001, 3003, 3005, 3007, 3017, 3019, 3021, 3023} are used for CQI computation.

In some aspects, one or more sub-configurations of the 4 sub-configurations may also indicate a power domain adaptation and/or a Type 2 spatial domain adaptation.

FIG. 9 is a diagram illustrating an example 900 in which sub-configuration 0 and sub-configuration 1 are active. As shown by reference number 905, the UE may receive a configuration and/or activation of the CSI-RS resource k at a first time. As shown by reference number 910, the UE may receive a release and/or deactivation of the CSI-RS resource k at a second time. As shown by reference number 915, the UE may receive dynamic signaling (e.g., DCI or a MAC-CE) triggering a CSI report and indication sub-configurations 0 and 1 at a third time. Thus, the CSI report may be an aperiodic or semi-persistent CSI report. As shown by reference number 920, an end of a PUSCH or PUCCH carrying one or more CSI reports may occur at a fourth time.

As shown by reference number 925, while the sub-configurations are not active, the number of active CSI-RS resources is identified (e.g., counted) as 1 and the number of active CSI-RS ports of the CSI-RS resource is identified (e.g., counted) as 32. This may include first stage counting, as described above. An active time of sub-configurations 0 and 1 is shown by reference number 930. As shown, in the active time, the number of active CSI-RS resources is identified (e.g., counted) as 2 and the number of active CSI-RS ports is identified (e.g., counted) as 48 (e.g., in second stage counting). In this example, the number of active CSI-RS resources is 2, not 3, because the UE may reuse memory of the CSI-RS resource denoted k for sub-configuration 0, which is the same as the CSI-RS resource denoted k. In this case, the UE may not re-use memory for sub-configuration 1, so sub-configuration 1 is still counted separately. For example, the CSI-RS resource may be identified (e.g., counted) M times for the M (2) active sub-configurations that can be used for CSI measurement and reporting. In some aspects, the CSI-RS resource may be identified (e.g., counted) once in a first stage, and may be identified (e.g., counted) (Y=X−1) one time in a second stage. Furthermore, the number of active CSI-RS ports may be identified (e.g., counted) as T=48 because P (described in connection with FIG. 8) is equal to 32 and the sum of Pₛ across all active sub-configurations that is equal to 48 (determined as 16+32). The maximum of P and the sum of Pₛ is 48.

As indicated above, FIG. 9 is provided as an example. Other examples may differ from what is described with regard to FIG. 9.

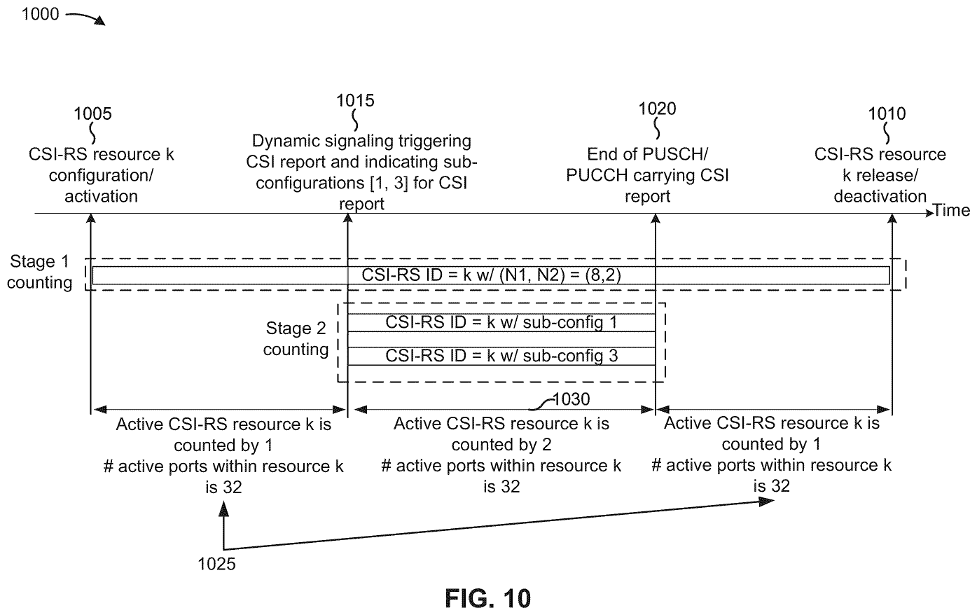

FIG. 10 is a diagram illustrating an example 1000 in which sub-configuration 1 and sub-configuration 3 are active. As shown by reference number 1005, the UE may receive a configuration and/or activation of the CSI-RS resource k at a first time. As shown by reference number 1010, the UE may receive a release and/or deactivation of the CSI-RS resource k at a second time. As shown by reference number 1015, the UE may receive dynamic signaling (e.g., DCI or a MAC-CE) triggering a CSI report and indication sub-configurations 1 and 3 at a third time. Thus, the CSI report may be an aperiodic or semi-persistent CSI report with a periodic or semi-persistent CSI-RS. As shown by reference number 1020, an end of a PUSCH or PUCCH carrying one or more CSI reports may occur at a fourth time.

As shown by reference number 1025, while the sub-configurations are not active, the number of active CSI-RS resources is identified (e.g., counted) as 1 and the number of active CSI-RS ports of the CSI-RS resource is identified (e.g., counted) as 32. This may include first stage counting, as described above. An active time of sub-configurations 1 and 3 is shown by reference number 1030. As shown, in the active time, the number of active CSI-RS resources is identified (e.g., counted) as 2 and the number of active CSI-RS ports is identified (e.g., counted) as 32 (e.g., in second stage counting). In this example, the number of active CSI-RS resources is 2, not 3, because the UE may reuse memory of the CSI-RS resource denoted k for one of sub-configuration 1 or 3. For example, the CSI-RS resource may be identified (e.g., counted) M times for the M (2) active sub-configurations that can be used for CSI measurement and reporting. In some aspects, the CSI-RS resource may be identified (e.g., counted) once in a first stage, and may be identified (e.g., counted) (Y=X−1) one time in a second stage. Furthermore, the number of active CSI-RS ports may be identified (e.g., counted) as T=32 because P (described in connection with FIG. 8) is equal to 32 and the sum of Pₛ across all active sub-configurations that is equal to 24 (determined as 16+8). The maximum of P and the sum of Pₛ is 32.

As indicated above, FIG. 10 is provided as an example. Other examples may differ from what is described with regard to FIG. 10.

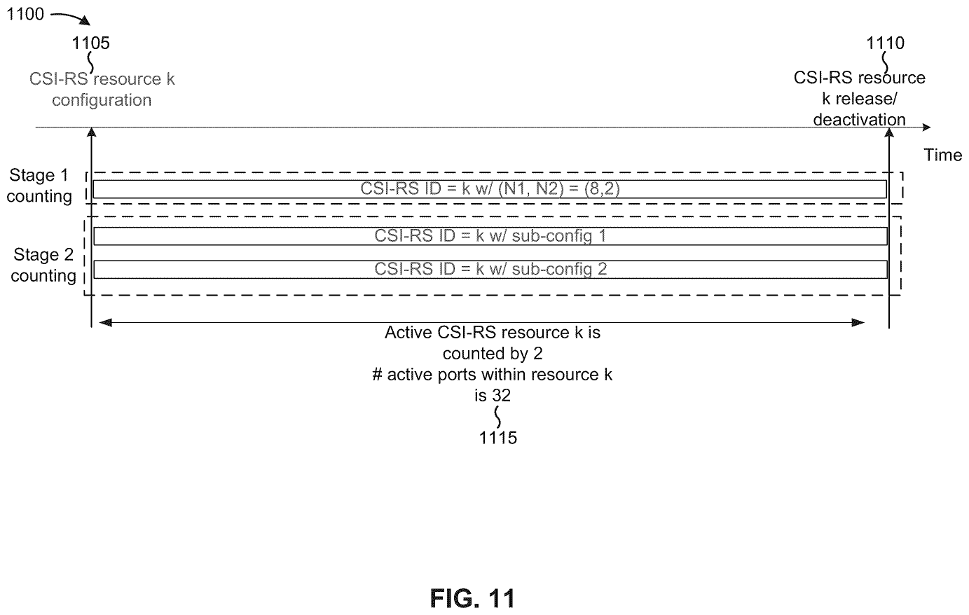

FIG. 11 is a diagram illustrating an example 1100 in which sub-configuration 1 and sub-configuration 2 are active. As shown by reference number 1105, the UE may receive a configuration and/or activation of the CSI-RS resource k at a first time. The configuration and/or activation may also indicate sub-configurations 1 and 2. As shown by reference number 1110, the UE may receive a release and/or deactivation of the CSI-RS resource k at a second time. Thus, example 1100 may illustrate a periodic CSI report with active sub-configurations 1 and 2.

As shown by reference number 1115, in the active time defined by reference numbers 1100 and 1105, the number of active CSI-RS resources is identified (e.g., counted) as 2 and the number of active CSI-RS ports is identified (e.g., counted) as 32 (e.g., in second stage counting). In this example, the number of CSI-RS resources is 2, not 3, because the UE may reuse memory of the CSI-RS resource denoted k for one of sub-configuration 1 or 2. For example, the CSI-RS resource may be identified (e.g., counted) M times for the M (2) active sub-configurations that can be used for CSI measurement and reporting. Furthermore, the number of CSI-RS ports may be identified (e.g., counted) as T=32 because P (described in connection with FIG. 8) is equal to 32 and the sum of Pₛ across all active sub-configurations that is equal to 32 (determined as 16+16). The maximum of P and the sum of Pₛ is 32.

As indicated above, FIG. 11 is provided as an example. Other examples may differ from what is described with regard to FIG. 11.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with techniques for identifying (e.g., counting) channel state information reference signal resources for spatial domain or power domain adaptation.

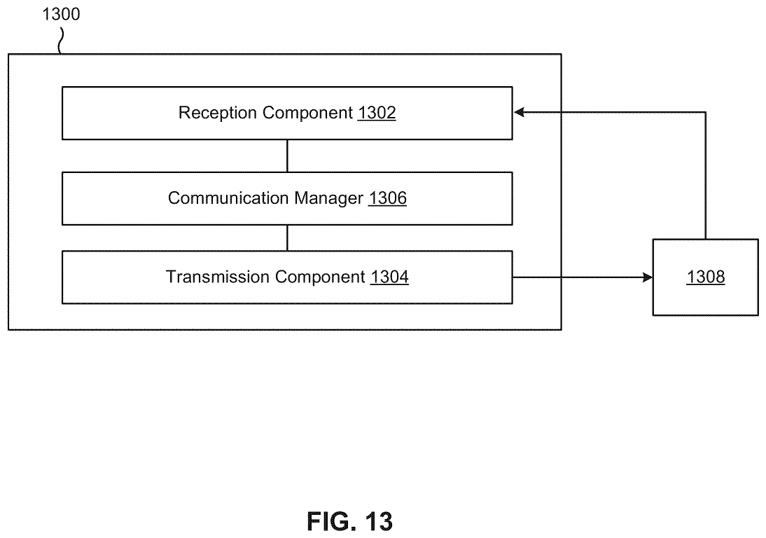

As shown in FIG. 12, in some aspects, process 1200 may include receiving a CSI report configuration indicating a CSI-RS resource for channel measurement and a set of sub-configurations, wherein each sub-configuration of the set of sub-configurations corresponds to a transmission setting for a CSI-RS (block 1210). For example, the UE (e.g., using reception component 1302 and/or communication manager 1306, depicted in FIG. 13) may receive a CSI report configuration indicating a CSI-RS resource for channel measurement and a set of sub-configurations, wherein each sub-configuration of the set of sub-configurations corresponds to a transmission setting for a CSI-RS, as described above. In some aspects, the sub-configurations are referred to as configurations. The transmission setting may relate to (e.g., identify) at least one of a CSI-RS port configuration or a power offset of the CSI-RS. In some aspects, the number of active CSI-RS resources and/or the number of active CSI-RS ports may be based at least in part on a CSI-RS resource type of the CSI-RS.

As further shown in FIG. 12, in some aspects, process 1200 may include identifying (e.g., counting) a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS, wherein the CSI-RS resource type comprises at least one of an aperiodic type, a semi-persistent type, or a periodic type (block 1220). For example, the UE (e.g., using communication manager 1306, depicted in FIG. 13) may identify (e.g., count) a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS, as described above.

As further shown in FIG. 12, in some aspects, process 1200 may include transmitting one or more CSI reports based on the subset of the set of sub-configurations (block 1230). For example, the UE (e.g., using transmission component 1304 and/or communication manager 1306, depicted in FIG. 13) may transmit one or more CSI reports based on the subset of the set of sub-configurations, as described above.

Process 1200 may include additional aspects, such as any single aspect or any combination of aspects described below and/or in connection with one or more other processes described elsewhere herein.

In a first aspect, identifying (e.g., counting) the number of active CSI-RS resources and the number of active CSI-RS ports for the CSI-RS resource is based at least in part on a CSI-RS resource type of the CSI-RS, wherein the CSI-RS resource type comprises at least one of an aperiodic type, a semi-persistent type, or a periodic type.

In a second aspect, alone or in combination with the first aspect, the subset of sub-configurations includes M sub-configurations, wherein M is an integer, wherein the subset of sub-configurations refer to the CSI-RS resource, and wherein identifying (e.g., counting) the number of active CSI-RS resources and the number of active CSI-RS ports for the CSI-RS resource further comprises identifying (e.g., counting) the CSI-RS resource M times.

In a third aspect, alone or in combination with one or more of the first and second aspects, identifying (e.g., counting) the number of active CSI-RS resources and the number of active CSI-RS ports for the CSI-RS resource further comprises identifying (e.g., counting) T CSI-RS ports, wherein T is an integer, and wherein T is based at least in part on at least one of a sum of CSI-RS ports configured in the subset of sub-configurations, or a number of CSI-RS ports configured in the CSI-RS resource.

In a fourth aspect, alone or in combination with one or more of the first through third aspects, identifying (e.g., counting) the T CSI-RS ports further comprises identifying (e.g., counting) the T CSI-RS ports based at least in part on the subset of sub-configurations being associated with adaptation of logical antenna ports.

In a fifth aspect, alone or in combination with one or more of the first through fourth aspects, identifying (e.g., counting) the number of active CSI-RS resources and the number of active CSI-RS ports for the CSI-RS resource further comprises identifying (e.g., counting) a number of CSI-RS ports configured in the CSI-RS resource M times.

In a sixth aspect, alone or in combination with one or more of the first through fifth aspects, the CSI-RS resource type is the aperiodic type, and wherein M is equal to a number of sub-configurations indicated to the UE via downlink signaling and referring to the CSI-RS resource.

In a seventh aspect, alone or in combination with one or more of the first through sixth aspects, the CSI-RS resource type is the semi-persistent type or the periodic type, and wherein M is equal to a number of sub-configurations included in the set of sub-configurations and referring to the CSI-RS resource.

In an eighth aspect, alone or in combination with one or more of the first through seventh aspects, the CSI-RS resource type is the semi-persistent type or the periodic type, and wherein M is based at least in part on one or more sub-configurations indicated in one or more trigger states associated with the CSI report configuration.

In a ninth aspect, alone or in combination with one or more of the first through eighth aspects, identifying (e.g., counting) the number of active CSI-RS resources and the number of active CSI-RS ports for the CSI-RS resource further comprises identifying (e.g., counting) the CSI-RS resource, and identifying (e.g., counting) the number of active CSI-RS resources and the number of active CSI-RS ports in association with the subset of sub-configurations.

In a tenth aspect, alone or in combination with one or more of the first through ninth aspects, identifying (e.g., counting) the number of active CSI-RS resources and the number of active CSI-RS ports in association with the subset of sub-configurations is based at least in part on an active time of the CSI-RS resource and CSI-RS ports of the resource.

In an eleventh aspect, alone or in combination with one or more of the first through tenth aspects, the one or more CSI reports comprise an aperiodic CSI report or a semi-persistent CSI report on a physical uplink shared channel, and wherein the active time begins at an end of a last symbol of a physical downlink control channel carrying a CSI trigger and ends at an end of the physical uplink shared channel.

In a twelfth aspect, alone or in combination with one or more of the first through eleventh aspects, the one or more CSI reports comprise a semi-persistent CSI report on a physical uplink control channel, and wherein the active time begins at an end of a time when a medium access control element containing a subset indication is applied, and ends at an end of the physical uplink control channel.

In a thirteenth aspect, alone or in combination with one or more of the first through twelfth aspects, the one or more CSI reports comprise a periodic CSI report, and wherein the active time begins at an end of a time when a periodic CSI-RS configuration of a resource set associated with the CSI-RS resource is configured, and ends when the periodic CSI-RS configuration is released.

In a fourteenth aspect, alone or in combination with one or more of the first through thirteenth aspects, the subset of sub-configurations includes X sub-configurations, wherein X is an integer, wherein the X sub-configurations refer to the CSI-RS resource, and wherein identifying (e.g., counting) the number of active CSI-RS resources and the number of active CSI-RS ports in association with the subset of sub-configurations further comprises identifying (e.g., counting) Y CSI-RS resources, where Y is equal to X minus 1.

In a fifteenth aspect, alone or in combination with one or more of the first through fourteenth aspects, identifying (e.g., counting) the number of CSI-RS resources and the number of CSI-RS ports further comprises identifying (e.g., counting) T CSI-RS ports, wherein T is an integer, and wherein T is based at least in part on at least one of a sum of CSI-RS ports of the subset of sub-configurations, or a number of CSI-RS ports configured in the CSI-RS resource.

In a sixteenth aspect, alone or in combination with one or more of the first through fifteenth aspects, process 1200 includes transmitting capability information indicating a capability for identifying (e.g., counting) CSI-RS resources or CSI-RS ports, wherein the capability is at a granularity of at least one of per UE, per band, per band combination, or per band per band combination.

In a seventeenth aspect, alone or in combination with one or more of the first through sixteenth aspects, transmitting the one or more CSI reports further comprises transmitting the one or more CSI reports in accordance with a processing timeline, wherein the processing timeline is based at least in part on the number of CSI-RS resources or the number of CSI-RS ports and is increased relative to a baseline for a high complexity CSI report.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 4-11. Additionally, or alternatively, the apparatus 1300 may be configured to perform one or more processes described herein, such as process 1200 of FIG. 12, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a CSI report configuration indicating a CSI-RS resource for channel measurement and a set of sub-configurations, wherein each sub-configuration of the set of sub-configurations corresponds to a transmission setting for a CSI-RS. The communication manager 1306 may identify (e.g., count) a number of CSI-RS resources and a number of CSI-RS ports for the CSI-RS resource, wherein the number of CSI-RS resources and the number of CSI-RS ports correspond to a subset of sub-configurations of the set of sub-configurations. The transmission component 1304 may transmit one or more CSI reports based on the subset of the set of sub-configurations.

The transmission component 1304 may transmit capability information indicating a capability for identifying (e.g., counting) CSI-RS resources or CSI-RS ports, wherein the capability is at a granularity of at least one of per UE, per band, per band combination, or per band per band combination.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

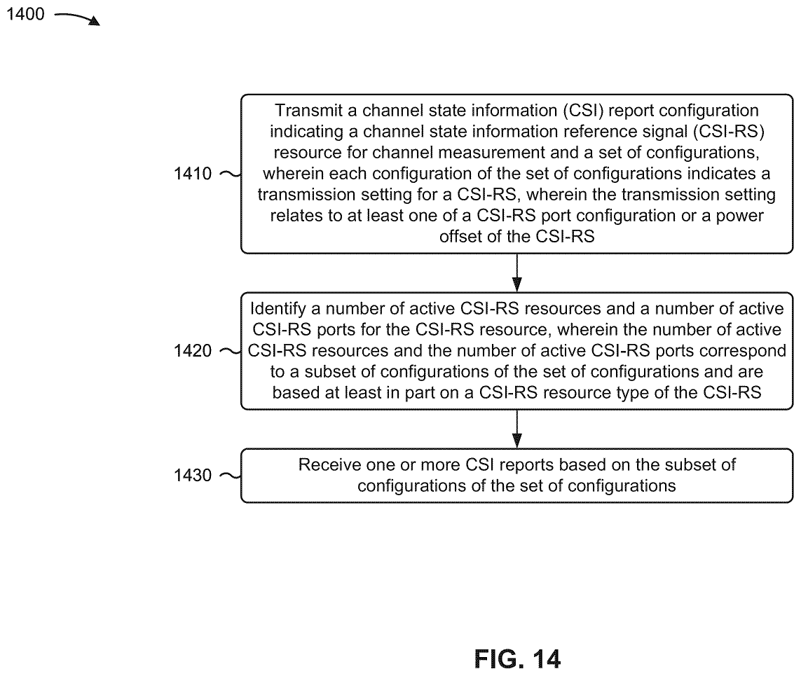

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with CSI-RSs.

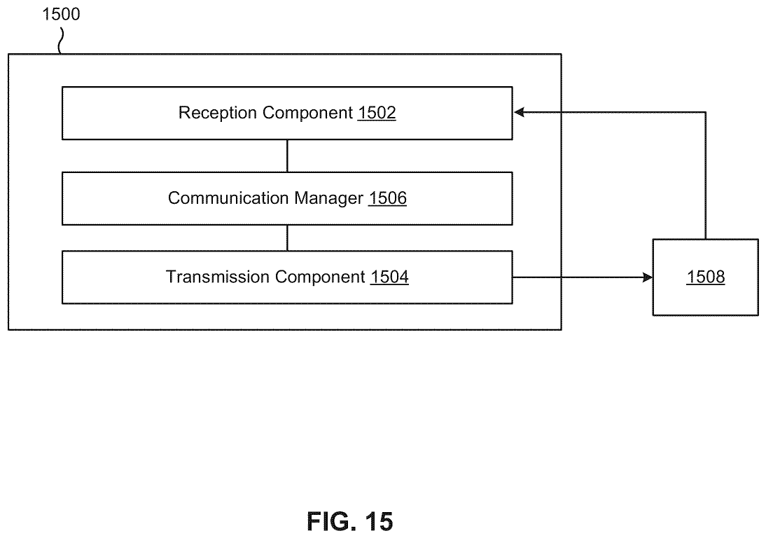

As shown in FIG. 14, in some aspects, process 1400 may include transmitting a CSI report configuration indicating a CSI-RS resource for channel measurement and a set of configurations, wherein each configuration of the set of configurations indicates a transmission setting for a CSI-RS, wherein the transmission setting relates to at least one of a CSI-RS port configuration or a power offset of the CSI-RS (block 1410). For example, the network node (e.g., using transmission component 1504 and/or communication manager 1506, depicted in FIG. 15) may transmit a CSI report configuration indicating a CSI-RS resource for channel measurement and a set of configurations, wherein each configuration of the set of configurations indicates a transmission setting for a CSI-RS, wherein the transmission setting relates to at least one of a CSI-RS port configuration or a power offset of the CSI-RS, as described above.

As further shown in FIG. 14, in some aspects, process 1400 may include identifying a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS (block 1420). For example, the network node (e.g., using communication manager 1506, depicted in FIG. 15) may identify a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS, as described above.

As further shown in FIG. 14, in some aspects, process 1400 may include receiving one or more CSI reports based on the subset of configurations of the set of configurations (block 1430). For example, the network node (e.g., using reception component 1502 and/or communication manager 1506, depicted in FIG. 15) may receive one or more CSI reports based on the subset of configurations of the set of configurations, as described above.

Process 1400 may include additional aspects, such as any single aspect or any combination of aspects described below and/or in connection with one or more other processes described elsewhere herein.

In a first aspect, the CSI-RS resource type comprises at least one of an aperiodic type, a semi-persistent type, or a periodic type.

In a second aspect, alone or in combination with the first aspect, the subset of configurations includes M configurations, wherein M is an integer, wherein the subset of configurations refer to the CSI-RS resource, and wherein identifying the number of active CSI-RS resources and the number of active CSI-RS ports for the CSI-RS resource further comprises identifying the CSI-RS resource M times.

In a third aspect, alone or in combination with one or more of the first and second aspects, identifying the number of active CSI-RS resources and the number of active CSI-RS ports for the CSI-RS resource further comprises identifying T CSI-RS ports, wherein T is an integer, and wherein T is based at least in part on a maximum of a sum of CSI-RS ports configured in the subset of configurations, and a number of CSI-RS ports configured in the CSI-RS resource.

In a fourth aspect, alone or in combination with one or more of the first through third aspects, identifying the T CSI-RS ports further comprises identify the T CSI-RS ports based at least in part on the subset of configurations indicating transmission settings that indicate one or more CSI-RS port configurations.

In a fifth aspect, alone or in combination with one or more of the first through fourth aspects, identifying the number of active CSI-RS resources and the number of active CSI-RS ports for the CSI-RS resource further comprises identifying a number of CSI-RS ports configured in the CSI-RS resource M times based at least in part on the subset of configurations indicating transmission settings that indicate one or more power offsets.

In a sixth aspect, alone or in combination with one or more of the first through fifth aspects, the one or more power offsets comprise at least one of a power offset between the CSI-RS and a synchronization signal block, or a power offset between a physical downlink shared channel and the CSI-RS.

In a seventh aspect, alone or in combination with one or more of the first through sixth aspects, the CSI-RS resource type is the aperiodic type, and wherein M is equal to a number of configurations indicated to the UE via downlink signaling and referring to the CSI-RS resource.

In an eighth aspect, alone or in combination with one or more of the first through seventh aspects, the CSI-RS resource type is the semi-persistent type or the periodic type, and wherein M is equal to a number of configurations included in the set of configurations and referring to the CSI-RS resource.

In a ninth aspect, alone or in combination with one or more of the first through eighth aspects, the CSI-RS resource type is the semi-persistent type or the periodic type, and wherein M is based at least in part on one or more configurations indicated in one or more trigger states associated with the CSI report configuration.

In a tenth aspect, alone or in combination with one or more of the first through ninth aspects, identifying the number of active CSI-RS resources and the number of active CSI-RS ports for the CSI-RS resource further comprises identifying the CSI-RS resource, and identifying the number of active CSI-RS resources and the number of active CSI-RS ports in association with the subset of configurations.

In an eleventh aspect, alone or in combination with one or more of the first through tenth aspects, identifying the number of active CSI-RS resources and the number of active CSI-RS ports in association with the subset of configurations is based at least in part on an active time of the CSI-RS resource and CSI-RS ports of the resource.

In a twelfth aspect, alone or in combination with one or more of the first through eleventh aspects, the one or more CSI reports comprise an aperiodic CSI report or a semi-persistent CSI report on a physical uplink shared channel, and wherein the active time begins at an end of a last symbol of a physical downlink control channel carrying a CSI trigger and ends at an end of the physical uplink shared channel.

In a thirteenth aspect, alone or in combination with one or more of the first through twelfth aspects, the one or more CSI reports comprise a semi-persistent CSI report on a physical uplink control channel, and wherein the active time begins at an end of a time when a medium access control element containing a subset indication is applied, and ends at an end of the physical uplink control channel.

In a fourteenth aspect, alone or in combination with one or more of the first through thirteenth aspects, the one or more CSI reports comprise a periodic CSI report, and wherein the active time begins at an end of a time when a periodic CSI-RS configuration of a resource set associated with the CSI-RS resource is configured, and ends when the periodic CSI-RS configuration is released.

In a fifteenth aspect, alone or in combination with one or more of the first through fourteenth aspects, receiving the one or more CSI reports further comprises receiving the one or more CSI reports in accordance with a processing timeline, wherein the processing timeline is based at least in part on the number of CSI-RS resources or the number of CSI-RS ports.

In a sixteenth aspect, alone or in combination with one or more of the first through fifteenth aspects, the set of configurations comprise sub-configurations of the CSI report configuration.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 4-11. Additionally, or alternatively, the apparatus 1500 may be configured to perform one or more processes described herein, such as process 1400 of FIG. 14 or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit a CSI report configuration indicating a CSI-RS resource for channel measurement and a set of configurations, wherein each configuration of the set of configurations indicates a transmission setting for a CSI-RS, wherein the transmission setting relates to at least one of a CSI-RS port configuration or a power offset of the CSI-RS. The communication manager 1506 may identify a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS. The reception component 1502 may receive one or more CSI reports based on the subset of configurations of the set of configurations.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving a channel state information (CSI) report configuration indicating a channel state information reference signal (CSI-RS) resource for channel measurement and a set of configurations, wherein each configuration of the set of configurations corresponds to a transmission setting for a CSI-RS, wherein the transmission setting relates to at least one of a CSI-RS port configuration or a power offset of the CSI-RS; identifying a number of active CSI-RS resources and a number of active CSI-RS ports for the CSI-RS resource, wherein the number of active CSI-RS resources and the number of active CSI-RS ports correspond to a subset of configurations of the set of configurations; and transmitting one or more CSI reports based on the subset of the set of configurations.

Aspect 2: The method of Aspect 1, wherein identifying the number of active CSI-RS resources and the number of active CSI-RS ports for the CSI-RS resource is based at least in part on a CSI-RS resource type of the CSI-RS, wherein the CSI-RS resource type comprises at least one of an aperiodic type, a semi-persistent type, or a periodic type.

Aspect 3: The method of Aspect 2, wherein the subset of configurations includes M configurations, wherein M is an integer, wherein the subset of configurations refer to the CSI-RS resource, and wherein identifying the number of active CSI-RS resources and the number of active CSI-RS ports for the CSI-RS resource further comprises identifying the CSI-RS resource M times.

Aspect 4: The method of Aspect 3, wherein identifying the number of active CSI-RS resources and the number of active CSI-RS ports for the CSI-RS resource further comprises identifying T CSI-RS ports, wherein T is an integer, and wherein T is based at least in part on at least one of: a sum of CSI-RS ports configured in the subset of configurations, or a number of CSI-RS ports configured in the CSI-RS resource.

Aspect 5: The method of Aspect 4, wherein identifying the T CSI-RS ports further comprises identifying the T CSI-RS ports based at least in part on the subset of configurations being associated with adaptation of logical antenna ports.

Aspect 6: The method of Aspect 3, wherein identifying the number of active CSI-RS resources and the number of active CSI-RS ports for the CSI-RS resource further comprises identifying a number of CSI-RS ports configured in the CSI-RS resource M times.

Aspect 7: The method of Aspect 3, wherein the CSI-RS resource type is the aperiodic type, and wherein M is equal to a number of configurations indicated to the UE via downlink signaling and referring to the CSI-RS resource.

Aspect 8: The method of Aspect 3, wherein the CSI-RS resource type is the semi-persistent type or the periodic type, and wherein M is equal to a number of configurations included in the set of configurations and referring to the CSI-RS resource.

Aspect 9: The method of Aspect 3, wherein the CSI-RS resource type is the semi-persistent type or the periodic type, and wherein M is based at least in part on one or more configurations indicated in one or more trigger states associated with the CSI report configuration.

Aspect 10: The method of any of Aspects 1-9, wherein identifying the number of active CSI-RS resources and the number of active CSI-RS ports for the CSI-RS resource further comprises: identifying the CSI-RS resource; and identifying the number of active CSI-RS resources and the number of active CSI-RS ports in association with the subset of configurations.

Aspect 11: The method of Aspect 10, wherein identifying the number of active CSI-RS resources and the number of active CSI-RS ports in association with the subset of configurations is based at least in part on an active time of the CSI-RS resource and CSI-RS ports of the resource.

Aspect 12: The method of Aspect 11, wherein the one or more CSI reports comprise an aperiodic CSI report or a semi-persistent CSI report on a physical uplink shared channel, and wherein the active time begins at an end of a last symbol of a physical downlink control channel carrying a CSI trigger and ends at an end of the physical uplink shared channel.

Aspect 13: The method of Aspect 11, wherein the one or more CSI reports comprise a semi-persistent CSI report on a physical uplink control channel, and wherein the active time begins at an end of a time when a medium access control element containing a subset indication is applied, and ends at an end of the physical uplink control channel.

Aspect 14: The method of Aspect 11, wherein the one or more CSI reports comprise a periodic CSI report, and wherein the active time begins at an end of a time when a periodic CSI-RS configuration of a resource set associated with the CSI-RS resource is configured, and ends when the periodic CSI-RS configuration is released.

Aspect 15: The method of Aspect 10, wherein the subset of configurations includes X configurations, wherein X is an integer, wherein the X configurations refer to the CSI-RS resource, and wherein identifying the number of active CSI-RS resources and the number of active CSI-RS ports in association with the subset of configurations further comprises identifying Y CSI-RS resources, where Y is equal to X minus 1. In some aspects, X is equal to a number of configurations that are indicated to the UE via downlink signaling and that refer to the CSI-RS resource.

Aspect 16: The method of Aspect 15, wherein identifying the number of CSI-RS resources and the number of CSI-RS ports further comprises identifying T CSI-RS ports, wherein T is an integer, and wherein T is based at least in part on at least one of: a sum of CSI-RS ports of the subset of configurations, or a number of CSI-RS ports configured in the CSI-RS resource.

Aspect 17: The method of any of Aspects 1-16, further comprising transmitting capability information indicating a capability for identifying CSI-RS resources or CSI-RS ports, wherein the capability is at a granularity of at least one of: per UE, per band, per band combination, or per band per band combination.

Aspect 18: The method of any of Aspects 1-17, wherein transmitting the one or more CSI reports further comprises transmitting the one or more CSI reports in accordance with a processing timeline, wherein the processing timeline is based at least in part on the number of CSI-RS resources or the number of CSI-RS ports and is increased relative to a baseline for a high complexity CSI report.

Aspect 19: A method of wireless communication performed by a network node, comprising: transmitting a channel state information (CSI) report configuration indicating a channel state information reference signal (CSI-RS) resource for channel measurement and a set of configurations, wherein each configuration of the set of configurations indicates a transmission setting for a CSI-RS, wherein the transmission setting relates to at least one of a CSI-RS port configuration or a power offset of the CSI-RS; identifying a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS; and receiving one or more CSI reports based on the subset of configurations of the set of configurations.

Aspect 20: The method of Aspect 19, wherein the CSI-RS resource type comprises at least one of an aperiodic type, a semi-persistent type, or a periodic type.

Aspect 21: The method of Aspect 20, wherein the subset of configurations includes M configurations, wherein M is an integer, wherein the subset of configurations refer to the CSI-RS resource, and wherein identifying the number of active CSI-RS resources and the number of active CSI-RS ports for the CSI-RS resource further comprises identifying the CSI-RS resource M times.

Aspect 22: The method of Aspect 21, wherein identifying the number of active CSI-RS resources and the number of active CSI-RS ports for the CSI-RS resource further comprises identifying T CSI-RS ports, wherein T is an integer, and wherein T is based at least in part on a maximum of: a sum of CSI-RS ports configured in the subset of configurations, and a number of CSI-RS ports configured in the CSI-RS resource.

Aspect 23: The method of Aspect 21, wherein identifying the T CSI-RS ports further comprises identify the T CSI-RS ports based at least in part on the subset of configurations indicating transmission settings that indicate one or more CSI-RS port configurations.

Aspect 24: The method of Aspect 21, wherein identifying the number of active CSI-RS resources and the number of active CSI-RS ports for the CSI-RS resource further comprises identifying a number of CSI-RS ports configured in the CSI-RS resource M times based at least in part on the subset of configurations indicating transmission settings that indicate one or more power offsets.

Aspect 25: The method of Aspect 24, wherein the one or more power offsets comprise at least one of a power offset between the CSI-RS and a synchronization signal block, or a power offset between a physical downlink shared channel and the CSI-RS.

Aspect 26: The method of Aspect 21, wherein the CSI-RS resource type is the aperiodic type, and wherein M is equal to a number of configurations indicated to the UE via downlink signaling and referring to the CSI-RS resource.

Aspect 27: The method of Aspect 21, wherein the CSI-RS resource type is the semi-persistent type or the periodic type, and wherein M is equal to a number of configurations included in the set of configurations and referring to the CSI-RS resource.

Aspect 28: The method of Aspect 21, wherein the CSI-RS resource type is the semi-persistent type or the periodic type, and wherein M is based at least in part on one or more configurations indicated in one or more trigger states associated with the CSI report configuration.

Aspect 29: The method of any of Aspects 19-28, wherein identifying the number of active CSI-RS resources and the number of active CSI-RS ports for the CSI-RS resource further comprises: identifying the CSI-RS resource; and identifying the number of active CSI-RS resources and the number of active CSI-RS ports in association with the subset of configurations.

Aspect 30: The method of Aspect 29, wherein identifying the number of active CSI-RS resources and the number of active CSI-RS ports in association with the subset of configurations is based at least in part on an active time of the CSI-RS resource and CSI-RS ports of the resource.

Aspect 31: The method of Aspect 29, wherein the one or more CSI reports comprise an aperiodic CSI report or a semi-persistent CSI report on a physical uplink shared channel, and wherein the active time begins at an end of a last symbol of a physical downlink control channel carrying a CSI trigger and ends at an end of the physical uplink shared channel.

Aspect 32: The method of Aspect 29, wherein the one or more CSI reports comprise a semi-persistent CSI report on a physical uplink control channel, and wherein the active time begins at an end of a time when a medium access control element containing a subset indication is applied, and ends at an end of the physical uplink control channel.

Aspect 33: The method of Aspect 32, wherein the one or more CSI reports comprise a periodic CSI report, and wherein the active time begins at an end of a time when a periodic CSI-RS configuration of a resource set associated with the CSI-RS resource is configured, and ends when the periodic CSI-RS configuration is released.

Aspect 34: The method of any of Aspects 19-33, wherein receiving the one or more CSI reports further comprises receiving the one or more CSI reports in accordance with a processing timeline, wherein the processing timeline is based at least in part on the number of CSI-RS resources or the number of CSI-RS ports.

Aspect 35: The method of any of Aspects 19-34, wherein the set of configurations comprise sub-configurations of the CSI report configuration.

Aspect 36: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-35.

Aspect 37: An apparatus for wireless communication at a device, the apparatus comprising one or more memories and one or more processors coupled to the one or more memories, the one or more processors configured to cause the device to perform the method of one or more of Aspects 1-35.

Aspect 38: An apparatus for wireless communication, the apparatus comprising at least one means for performing the method of one or more of Aspects 1-35.

Aspect 39: A non-transitory computer-readable medium storing code for wireless communication, the code comprising instructions executable by one or more processors to perform the method of one or more of Aspects 1-35.

Aspect 40: A non-transitory computer-readable medium storing a set of instructions for wireless communication, the set of instructions comprising one or more instructions that, when executed by one or more processors of a device, cause the device to perform the method of one or more of Aspects 1-35.

Aspect 41: A device for wireless communication, the device comprising a processing system that includes one or more processors and one or more memories coupled with the one or more processors, the processing system configured to cause the device to perform the method of one or more of Aspects 1-35.

Aspect 42: An apparatus for wireless communication at a device, the apparatus comprising one or more memories and one or more processors coupled to the one or more memories, the one or more processors individually or collectively configured to cause the device to perform the method of one or more of Aspects 1-35.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a user equipment (UE), comprising:
one or more memories; and
one or more processors, coupled to the one or more memories, configured to cause the UE to:
receive a channel state information (CSI) report configuration indicating a channel state information reference signal (CSI-RS) resource for channel measurement and a set of configurations, wherein each configuration of the set of configurations refers to at least part of the CSI-RS resource, wherein each configuration of the set of configurations indicates a transmission setting for a CSI-RS, wherein the transmission setting indicates at least one of a CSI-RS port configuration or a power offset of the CSI-RS;
identify a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS, wherein the CSI-RS resource type comprises at least one of an aperiodic type, a semi-persistent type, or a periodic type; and
transmit one or more CSI reports based at least in part on the subset of configurations of the set of configurations.

2. The apparatus of claim 1, wherein the subset of configurations includes M configurations, wherein M is an integer, wherein the subset of configurations refer to the CSI-RS resource, and wherein the one or more processors, to identify the number of active CSI-RS resources and the number of active CSI-RS ports for the CSI-RS resource, are configured to cause the UE to identify the CSI-RS resource M times.

3. The apparatus of claim 2, wherein the one or more processors, to identify the number of active CSI-RS resources and the number of active CSI-RS ports for the CSI-RS resource, are configured to cause the UE to identify T CSI-RS ports, wherein T is an integer, and wherein T is based at least in part on a maximum of:
a sum of CSI-RS ports configured in the subset of configurations, and
a number of CSI-RS ports configured in the CSI-RS resource.

4. The apparatus of claim 3, wherein the one or more processors, to cause the UE to identify the T CSI-RS ports, are configured to cause the UE to identify the T CSI-RS ports based at least in part on the subset of configurations indicating transmission settings that indicate one or more CSI-RS port configurations.

5. The apparatus of claim 2, wherein the one or more processors, to cause the UE to identify the number of active CSI-RS resources and the number of active CSI-RS ports for the CSI-RS resource, are configured to cause the UE to identify a number of CSI-RS ports configured in the CSI-RS resource M times based at least in part on the subset of configurations indicating transmission settings that indicate one or more power offsets.

6. The apparatus of claim 5, wherein the one or more power offsets comprise at least one of a power offset between the CSI-RS and a synchronization signal block, or a power offset between a physical downlink shared channel and the CSI-RS.

7. The apparatus of claim 2, wherein the CSI-RS resource type is the aperiodic type, and wherein M is equal to a number of configurations indicated to the UE via downlink signaling and referring to the CSI-RS resource.

8. The apparatus of claim 2, wherein the CSI-RS resource type is the semi-persistent type or the periodic type, and wherein M is equal to a number of configurations included in the set of configurations and referring to the CSI-RS resource.

9. The apparatus of claim 2, wherein the CSI-RS resource type is the semi-persistent type or the periodic type, and wherein M is based at least in part on one or more configurations indicated in one or more trigger states associated with the CSI report configuration.

10. The apparatus of claim 1, wherein the one or more processors, to cause the UE to identify the number of active CSI-RS resources and the number of active CSI-RS ports for the CSI-RS resource, are configured to cause the UE to:
identify the CSI-RS resource; and
identify the number of active CSI-RS resources and the number of active CSI-RS ports in association with the subset of configurations.

11. The apparatus of claim 10, wherein identifying the number of active CSI-RS resources and the number of active CSI-RS ports in association with the subset of configurations is based at least in part on an active time of the CSI-RS resource and CSI-RS ports of the resource.

12. The apparatus of claim 11, wherein the one or more CSI reports comprise an aperiodic CSI report or a semi-persistent CSI report on a physical uplink shared channel, and wherein the active time begins at an end of a last symbol of a physical downlink control channel carrying a CSI trigger and ends at an end of the physical uplink shared channel carrying the one or more CSI reports.

13. The apparatus of claim 11, wherein the one or more CSI reports comprise a semi-persistent CSI report on a physical uplink control channel, and wherein the active time begins at an end of a time when a medium access control element containing a subset indication is applied, and ends at an end of the physical uplink control channel.

14. The apparatus of claim 11, wherein the one or more CSI reports comprise a periodic CSI report, and wherein the active time begins at an end of a time when a periodic CSI-RS configuration of a resource set associated with the CSI-RS resource is configured, and ends when the periodic CSI-RS configuration is released.

15. The apparatus of claim 10, wherein the subset of configurations includes X configurations, wherein X is an integer, wherein the X configurations refer to the CSI-RS resource, and wherein identifying the number of active CSI-RS resources and the number of active CSI-RS ports in association with the subset of configurations further comprises identifying Y CSI-RS resources, where Y is equal to X minus 1.

16. The apparatus of claim 15, wherein the one or more processors, to identify the number of active CSI-RS resources and the number of active CSI-RS ports for the CSI-RS resource, are configured to cause the UE to identify T CSI-RS ports, wherein T is an integer, and wherein T is based at least in part on a maximum of:
a sum of CSI-RS ports configured in the subset of configurations, and
a number of CSI-RS ports configured in the CSI-RS resource.

17. The apparatus of claim 15, wherein X is equal to a number of configurations that are indicated to the UE via downlink signaling and that refer to the CSI-RS resource.

18. The apparatus of claim 1, wherein the one or more processors are further configured to cause the UE to transmit capability information indicating a capability for identifying CSI-RS resources or CSI-RS ports, wherein the capability is at a granularity of at least one of:
per UE,
per band,
per band combination, or
per band per band combination.

19. The apparatus of claim 1, wherein the one or more processors, to cause the UE to transmit the one or more CSI reports, are configured to cause the UE to transmit the one or more CSI reports in accordance with a processing timeline, wherein the processing timeline is based at least in part on the number of CSI-RS resources or the number of CSI-RS ports.

20. The apparatus of claim 1, wherein the set of configurations comprise sub-configurations of the CSI report configuration.

21. The apparatus of claim 1, wherein the one or more processors are further configured to receive an indication of the subset of configurations of the set of configurations.

22. The apparatus of claim 1, wherein the one or more processors are further configured to compute a channel quality indicator in accordance with the subset of configurations.

23. An apparatus for wireless communication at a network node, comprising:
one or more memories; and
one or more processors, coupled to the one or more memories, configured to cause the network node to:
transmit a channel state information (CSI) report configuration indicating a channel state information reference signal (CSI-RS) resource for channel measurement and a set of configurations, wherein each configuration of the set of configurations refers to at least part of the CSI-RS resource, wherein each configuration of the set of configurations indicates a transmission setting for a CSI-RS, wherein the transmission setting relates to at least one of a CSI-RS port configuration or a power offset of the CSI-RS;
identify a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS, wherein the CSI-RS resource type comprises at least one of an aperiodic type, a semi-persistent type, or a periodic type; and
receive one or more CSI reports based at least in part on the subset of configurations of the set of configurations.

24. The apparatus of claim 23, wherein the subset of configurations includes M configurations, wherein M is an integer, wherein the subset of configurations refer to the CSI-RS resource, and wherein the one or more processors, to cause the network node to identify the number of active CSI-RS resources and the number of active CSI-RS ports for the CSI-RS resource, are configured to cause the network node to identify the CSI-RS resource M times.

25. The apparatus of claim 24, wherein the one or more processors, to cause the network node to identify the number of active CSI-RS resources and the number of active CSI-RS ports for the CSI-RS resource, are configured to cause the network node to identify T CSI-RS ports, wherein T is an integer, and wherein T is based at least in part on a maximum of:
a sum of CSI-RS ports configured in the subset of configurations, and
a number of CSI-RS ports configured in the CSI-RS resource.

26. The apparatus of claim 24, wherein the one or more processors, to cause the network node to identify the T CSI-RS ports, are configured to cause the network node to identify the T CSI-RS ports based at least in part on the subset of configurations indicating transmission settings that indicate one or more CSI-RS port configurations.

27. The apparatus of claim 24, wherein the one or more processors, to cause the network node to identify the number of active CSI-RS resources and the number of active CSI-RS ports for the CSI-RS resource, are configured to cause the network node to identify a number of CSI-RS ports configured in the CSI-RS resource M times based at least in part on the subset of configurations indicating transmission settings that indicate one or more power offsets.

28. The apparatus of claim 27, wherein the one or more power offsets comprise at least one of a power offset between the CSI-RS and a synchronization signal block, or a power offset between a physical downlink shared channel and the CSI-RS.

29. A method of wireless communication performed by a user equipment (UE), comprising:
receiving a channel state information (CSI) report configuration indicating a channel state information reference signal (CSI-RS) resource for channel measurement and a set of configurations, wherein each configuration of the set of configurations refers to at least part of the CSI-RS resource, wherein each configuration of the set of configurations indicates a transmission setting for a CSI-RS, wherein the transmission setting relates to at least one of a CSI-RS port configuration or a power offset of the CSI-RS;
identifying a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS, wherein the CSI-RS resource type comprises at least one of an aperiodic type, a semi-persistent type, or a periodic type; and
transmitting one or more CSI reports based at least in part on the subset of configurations of the set of configurations.

30. A non-transitory computer-readable medium storing a set of instructions for wireless communication, the set of instructions comprising:
one or more instructions that, when executed by one or more processors of a user equipment (UE), cause the UE to:
receive a channel state information (CSI) report configuration indicating a channel state information reference signal (CSI-RS) resource for channel measurement and a set of configurations, wherein each configuration of the set of configurations refers to at least part of the CSI-RS resource, wherein each configuration of the set of configurations indicates a transmission setting for a CSI-RS, wherein the transmission setting relates to at least one of a CSI-RS port configuration or a power offset of the CSI-RS;
identify a number of active CSI-RS resources and a number of active CSI-RS ports for the CSI-RS resource, wherein the number of active CSI-RS resources and the number of active CSI-RS ports correspond to a subset of configurations of the set of configurations and are based at least in part on a CSI-RS resource type of the CSI-RS, wherein the CSI-RS resource type comprises at least one of an aperiodic type, a semi-persistent type, or a periodic type; and
transmit one or more CSI reports based at least in part on the subset of configurations of the set of configurations.
